(19) United States
(12) Patent Application Publication
(10) Pub. No.: US 2001/0039657 A1
(43) Pub. Date: Nov. 8, 2001

(54) Methods, systems and devices for selectively presenting and sorting data content

(75) Inventors: Stephan D. Fopeano, Los Angeles, CA (US); Daniel D. Schwartz, Arlington, MA (US); Raymond A. Dobson, East Orleans, MA (US)

Correspondence Address: Pillsbury Madison & Sutro LLP, Intellectual Property Group, East Tower, Ninth Floor, 1100 New York Avenue, N.W., Washington, DC, 20005-3918, US

(73) Assignee: TVMentor, Inc., Los Angeles, CA (US)

(21) Appl. No.: 09/842,843

(22) Filed: Apr. 27, 2001

Related U.S. Application Data
(60) Provisional application No. 60/200,374, filed on Apr. 28, 2000.

(51) Int. Cl. H04N 7/16

(52) U.S. Cl. 725/9; 725/34; 725/46

(57) ABSTRACT

A system, method and equipment may be implemented so that data content is selectively presented to an audience based on discrimination criteria specified by a user as well as categorization data, which is associated with the data content and provided by a trusted third-party selected by the user. Additionally, in accordance with an exemplary embodiment of the invention, labels corresponding to the data content may be presented in an index in a specialized format based on the discrimination criteria.

### BACKGROUND OF THE INVENTION

1. Field of the Invention

This invention relates generally to data content management. More specifically, the invention is related to systems, methods and equipment for selectively presenting data content to an audience or sorting that data content based on characteristics selected by a user and on information about the data content provided by a trusted third-party.

2. Description of the Related Art

In this, the information age, data is more readily available for mass consumption than ever before. As a result, the average individual and household has more opportunity to receive information from many new media and in larger quantities than ever. For example, individuals routinely have access to television programs, radio programs and web-based data content. By subscribing to a cable television provider, an individual easily has access to sometimes more than a hundred television channels. With the use of a satellite dish, that individual may receive hundreds of television channels. Similarly, although radio stations are prevalent, many more radio stations are easily received by using the Internet, thereby providing the ability to receive programming from thousands of radio stations. Additionally, the Internet provides the opportunity to access virtually unlimited data content through millions of web-pages. Each of these web-pages may provide access to audio, visual, audio-visual, text, graphic or multi-media data content.

However, with this increased access to data content, comes an increased need to manage the data so that it may be accessed in a meaningful way and be useful to a user or audience. Additionally, with this increased data access, it becomes more difficult to identify appropriate, beneficial and inappropriate data content for an audience, whether that audience be a five-year old child or a forty-year old sports fan.

Moreover, recent statistics indicate that the average American child will have seen 200,000 murders on television programs by the time she/he is 18. Additionally, it has recently been reported that three out of four violent acts on television go unpunished. This is particularly troubling when it is appreciated that most American children receive approximately 60% of their information from television.

Accordingly, newly developed technology has been directed at techniques to permit a viewer to selectively block reception and display of undesirable television programming. Conventionally, an electronic program guide (EPG) data can be transmitted to television receivers to provide television program information that identifies the individual television programs that are transmitted over available broadcast channels, together with the time of day that each such program is broadcasted. This EPG data can be transmitted to television receivers, either by cable transmission, direct satellite broadcast transmission, conventional over-the-air transmission or web-based communication. Such electronic television scheduling data permits a user to display information indicating what television programs are available throughout a particular day, week, month, etc. For a more detailed description of how EPG data may be used, see, e.g., U.S. Pat. No. 5,583,576, issued to Perlman et al. on Dec. 10, 1996, incorporated herein by reference in its entirety.

As explained in U.S. Pat. No. 5,583,576, it is conventionally known to selectively block the reception and/or display of television programs due to, for example, the content of such programs. For example, parents can prevent reception of television programs containing sexually explicit or violent content. Such parental “lock-out” systems often block reception and/or display of entire broadcast channels, for example, a channel that provides programming for mature audiences. Alternatively, the reception of television programs on particular channels may be inhibited during only certain times of the day.

Part of a conventional EPG includes information indicating whether a particular program includes a specific type of data content, e.g., sexually explicit or violent data. The National Association of Broadcasters (NAB), the National Cable Television Association (NCTA) and the Motion Picture Association of America (MPAA) have jointly formulated a set of guidelines known conventionally as the “TV Parental Guidelines”. These Guidelines apply to all television programming except for news, sports and unedited MPAA rated movies on premium cable channels. Under these Guidelines, there are six ratings: TV-Y (designed and appropriate for all children), TV-Y7 (designed and appropriate for children age seven years and above), TV-G (suitable for all ages); TV-PG (may not be suitable for younger children), TV-14 (may be unsuitable for children under fourteen years of age) and TV-MA (designed and suitable for adults and unsuitable for children under age seventeen years).

Conventional v-chip technology provides the ability to block display of programs with specific ratings. An indication of the v-chip program rating information is included in line 21 of the Vertical Blanking Interval (VBI) associated with each frame of a television program. This rating information is available to newspapers and publishers of printed and electronic program guides and is included in these newspapers and guides for review by viewers.

However, many users of v-chips have complained that the use of the v-chip is highly inconvenient. For example, if a parent wishes to shield his/her child from certain television programming, but then also wants to watch this programming, e.g., after the child has gone to bed, these parents are forced to manipulate a series of small buttons on the back of the television set every time they want to view such programs. Then they must reset the television so that their child may not watch these programs the following morning.

Another issue is that of the reliability of the data discrimination provided by the v-chip technology. Using the v-chip technology, parents themselves are not the ones who decide what is unacceptable for their children to watch. Rather, the authority lies in the hands of government appointed commission to decide what is unfit for children viewers. However, what parents believe is unacceptable may be inconsistent with what the government or its commission may believe is unacceptable. The effect is that some programs that are desired by a household are blocked out and some programs that are unacceptable according to the household are not blocked.

### SUMMARY OF THE INVENTION

Therefore, the exemplary embodiments of the present invention provide an alternative to the conventional technologies that are defective for the reasons explained above. In accordance with the exemplary embodiments of the invention, systems, methods or equipment are implemented so that data content is selectively presented to an audience, e.g., an entire household, a child or children, a parent, or an individual, or group of individuals, based on: (a) discrimination criteria specified by a user, e.g., an individual who may or may not be a parent, a caregiver, a teacher, a counselor, a doctor, etc., as well as (b) categorization data, which is associated with the data content and provided by a trusted third-party. Additionally, in accordance with an exemplary embodiment of the invention, labels corresponding to the data content can be presented in an index in a specialized format based on the discrimination criteria.

In a first exemplary embodiment of the invention, received broadcast data content is selectively output based on schedule-based categorization data provided by a trusted third-party and based on discrimination criteria provided by a user.

In a second exemplary embodiment of the invention, broadcast data content is selectively received at a customer premises based on schedule-based categorization data provided by a trusted third-party and based on discrimination criteria provided by a user.

In a third exemplary embodiment of the invention, data content is selectively broadcast to a customer premises based on schedule-based categorization data provided by a trusted third-party and based on discrimination criteria provided by a user.

In a fourth exemplary embodiment of the invention, labels associated with portions of broadcast data are sorted and presented in a specialized format that indicates a level of appropriateness based on schedule-based categorization data provided by a trusted third-party and based on discrimination criteria provided by a user.

In a fifth exemplary embodiment of the invention, data content is selectively presented based on categorization data provided by a trusted third-party and based on discrimination criteria provided by a user.

In a sixth exemplary embodiment of the invention, labels associated with portions of data content are sorted and presented in a specialized format that indicates a level of appropriateness based on categorization data provided by a trusted third-party and based on discrimination criteria provided by a user.

These and other features and advantages of this invention are described in, or are apparent from, the following description of the apparatus/systems and methods according to this invention.

### BRIEF DESCRIPTION OF THE DRAWINGS

The benefits, objects and advantages of the present invention will be readily appreciated and understood from consideration of the following detailed description of the exemplary embodiments of this invention, when taken with the accompanying drawings, in which same numbered elements are identical and:

FIG. 1 is a flowchart illustrating one exemplary method of interfacing with a user to set at least one discrimination criterion and/or at least one trusted third-party in accordance with the exemplary embodiments of the invention;

FIG. 2 is a block diagram illustrating one exemplary system architecture that may implement the first exemplary embodiment of the invention;

FIG. 3 is a flowchart illustrating one exemplary method for implementing the first exemplary embodiment of the invention;

FIG. 4 is a block diagram illustrating one exemplary system architecture that may implement the second exemplary embodiment of the invention;

FIG. 5 is a flowchart illustrating one exemplary method for implementing the second exemplary embodiment of the invention;

FIG. 6 is a block diagram illustrating one exemplary system architecture that may implement the third exemplary embodiment of the invention;

FIG. 7 is a flowchart illustrating one exemplary method for implementing the third exemplary embodiment of the invention;

FIG. 8 is a block diagram illustrating one exemplary system architecture that may implement the fourth exemplary embodiment of the invention;

FIG. 9 is a flowchart illustrating one exemplary method for implementing the fourth exemplary embodiment of the invention;

FIG. 10 illustrates one example of a graphical user interface generated by the first through fourth exemplary embodiments of the invention;

FIG. 11 is a block diagram illustrating one exemplary system architecture that may implement the fifth exemplary embodiment of the invention;

FIG. 12 is a flowchart illustrating one exemplary method for implementing the fifth exemplary embodiment of the invention;

FIG. 13 is a block diagram illustrating one exemplary system architecture that may implement the sixth exemplary embodiment of the invention; and

FIG. 14 is a flowchart illustrating one exemplary method for implementing the sixth exemplary embodiment of the invention.

### DETAILED DESCRIPTION OF EXEMPLARY EMBODIMENTS

With the increased work and personal responsibilities facing individuals today and the ever increasing amount of data available for consumption via television, radio, and computer networks, it is becoming increasingly difficult for individuals to identify information that they are interested in and consider valuable. Some individuals wish to perform this task not only for themselves, but also for others. For example, parents may want to be able to ensure that their children are being exposed to information that will foster their intellectual, emotional or spiritual health. However, these parents may not be able to gauge the television, radio and multi-media programming that their children are exposed to through out the day.

With an ever increasing number of media types, e.g., television, radio, multimedia over publicly accessible networks such as the Internet, and an ever increasing amount of data content provided by those media, it is becoming increasingly difficult to review and/or preview data content. For example, with a hundred channels (and more to come) it is becoming increasingly difficult to monitor a child's television viewing. There are some broadcast television and radio programs that are inappropriate for younger audiences because, for example, they contain violent or sexually-explicit content. However, there are also some broadcast television and radio programs that are appropriate and beneficial for younger audiences because, for example, they are less violent or are designed to match a child's age or interests, even school studies. Unfortunately, often parents lack the time or capability to seek out and identify programs that are appropriate and beneficial for their children.

As an example of the utility of the exemplary embodiments of the invention, a user, e.g., a parent, may use the exemplary embodiment of the invention to selectively present specific types of television programs to his/her child. For example, the exemplary embodiments of the invention may be used to selectively present television programs that have been recommended by a particular religious organization (acting as a trusted third-party). In such a situation, it is foreseeable, that the user may set up discrimination criteria so that only programs endorsed, approved or recommended for viewing by, for example, children under the age of five-years may be viewed on a television set between the hours of 7:00 AM and 5:00 PM. In such an example, television programming may be previewed by a representative(s) of that particular religious organization, and that representative(s) would rate and/or categorize the data content contained therein. The categorization data would then be provided by that representative(s) as a service to the user.

Prior to describing the exemplary embodiments of the invention in further detail, further explanation will now be made of various terminology used in the description. Throughout the description of the exemplary invention embodiments, the term “user” is meant to refer to an individual, or individuals, that may interact with a system or equipment or participate with methods designed in accordance with the invention so as to control selective presentation and/or sorting of data content. That is, a user is an entity that has control over selection of discrimination criteria and/or a trusted third-party. For example, a user may be a parent, a teacher, a counselor or any individual in charge of providing selective presentation of data content for a customer premises, such as a household, facility, e.g., a school, a hospital, a child care facility, a correctional facility, a dormitory, etc.

In distinction, the term “audience” refers to an individual or individuals that do not necessarily have control over selection of discrimination criteria and/or a trusted third-party. For example, an audience may include one or more individuals that are children in the care of a parent, teacher, babysitter, child-care provider, counselor, etc., a patient in a care facility, an inmate in a correctional facility, etc.

However, it should be appreciated that a user may also be an audience or audience member. For example, as explained below, at least one exemplary embodiment of the invention provides the opportunity for a user to more easily identify data content, e.g., television programs, which are of particular interest to the user. In such a situation, it should be appreciated that the user is also the audience that is being exposed to the selective presentation of the data content. For example, the individual is acting as a user when he selects discrimination criteria and a trusted third-party, which enables selective presentation or identification of all cooking shows endorsed by the American Culinary Association. However, he is acting as an audience when he is exposed to the selectively presented or identified list of cooking shows.

The term “data content” refers to information in a form suitable for processing for presentation, storage or manipulation by a user, e.g., audio-visual data, visual data, audio data, graphics, text data, or multimedia data. For example, data content may include a television program or radio show. Alternatively, data content may include links to web-pages located on the Internet. Therefore, it should be appreciated that data content may be broadcast data that is broadcast based on a schedule, as in the case of a television program or radio transmission and/or may be data content such as text, graphics or multimedia data, e.g., available on demand over a medium such as the Internet. Additionally, data content may include a book or publication that is downloadable from a network.

The term “trusted third-party” refers to a third-party that provides data content analysis services. Such a trusted third-party may be an individual, but is more likely a group of individuals, who review, or preview data content prior to that content being provided to a particular user, prior to that data content being accessed by a particular user, etc. The trusted third-party may be affiliated with a particular area of interest for a user, a household, a premises, or a facility. The trusted third-party may be selected by a user from a plurality of potential trusted third-parties, for example, dedicated program reviewing organizations, religious organizations, educational organizations, or special interest organizations.

The terms “discrimination criteria” and “discrimination criterion” are meant to refer to characteristics or a characteristic, respectively, selected by a user to be used during a process of determining what data content is most appropriate for presentation. Discrimination criteria may relate to either positive requirements, for example, data relating to music, education, religion, sports, etc., or negative requirements, for example, data not relating to violent or sexually-explicit content, horror movies, etc.

The term “categorization data” is meant to refer to information indicating at least one characteristic of the data content. For example, categorization data, like discrimination criteria, may relate to either positive requirements, for example, data relating to music, education, religion, sports, etc., or negative requirements, for example, data not relating to violent or sexually-explicit content, etc. The categorization data and discrimination criteria may, and preferably should, correspond with one another. That is, discrimination criteria potentially selected by a user should mirror categorization data provided by a trusted third-party. For example, if a user selects a discrimination criterion indicating that he/she is interested in non-violent drama television programs, it is preferable that at least one trusted third-party by the user provides categorization data that indicates whether data content contains a non-violent drama television program.

Implementation of the exemplary embodiments of the invention allows access to knowledge and insight of various “trusted third-parties”, e.g., experts in areas of interest (e.g., hobbies, religions, etc.), experts in various medical fields, experts in the fields of child development, child psychiatry, education, media studies, and ethics, by individuals to help guide them in selecting data content for presentation to themselves and to other individuals, e.g., their children, their patients, their wards, etc.

One potential benefit of using categorization data is that it allows the possibility of providing further information about data content that may be used to determine the appropriateness of exposing an audience to that data content. For example, a television program may have a specific level of violent activity. However, any potential benefit associated with the programming may differ based on subject matter content. Therefore, if a determination of appropriateness is based solely on the amount of violence shown in a television program, then both a police drama and a documentary on the civil rights movement may be identified as inappropriate for a particular audience.

While the v-chip technology may provide a rating of TV14-V, it only indicates that the program is not recommended for children under 14 because of violence. This approach is deficient because it removes the opportunity to view programming, regardless of the context of the violence, which parents may feel is appropriate for their child. Therefore, the exemplary embodiments of the invention provide a content description system that is more comprehensive and personalized than mere blanket ratings systems. By providing categorization data that indicates not only how much violence is present, but what intensity of violence, and violence in what context, a user, e.g., a parent, is provided with information indicating that the documentary does contain violence, but that it does so within an historical context that serves an educational purpose.

Categorization data may or may not be schedule-based, i.e., organized in a format that is associated with a schedule of data content availability. Therefore, at least one exemplary embodiment of the invention performs schedule-based discrimination of whether or not to present particular data content to an audience. Such would be the case with broadcast data that is broadcast based on a specific schedule. This schedule-based discrimination is performed based, in part, on schedule-based categorization data corresponding to the data content being broadcast on various channels or stations. It is foreseeable that such schedule-based categorization data may be included in an EPG that also indicates a program identification, start time and date and end time and date. Alternatively, the schedule-based categorization data may be linked to the data within the EPG or may be separate from the EPG.

Categorization data provided by the trusted third-party may include information specific to various abstraction levels of the data content. For example, if the data content is schedule-based, e.g., a broadcast television program containing audio-visual data for a particular episode of a television series, categorization data may include information relating to that particular episode and/or categorization data relating to that television series. Alternatively, if the data content is a broadcast audio program containing audio data for a particular episode of a radio series, categorization data may include schedule-based information relating to that particular episode and/or categorization data relating to that radio program series. Further, if the data content being broadcast is text or multi-media data linked to, for example, audio, audio-visual, or visual data, then categorization data may include schedule-based information specific to the text or multi-media data content or, for example, a link to a Web-site including the text or multi-media data content. Although schedule-based discrimination of data content may be performed by referring to schedule-based categorization data, schedule-based discrimination may also be performed based, in part, on schedule-based discrimination criteria that indicate what criteria should be taken into consideration during a specified period of time. For example, a user may indicate which discrimination criteria should be considered during specific time periods during a day, a week or any other identifiable time period.

The term “customer premises equipment”, or CPE, generally refers to a number of different types of devices. For example, CPE may include equipment that receives and decodes television programs that are transmitted by cable systems or by direct satellite broadcast systems, e.g., set-top boxes. Additionally, the CPE may include hardware and software used to perform those functions whether they are included in a set-top converters or boxes, a television set, a computer or a monitor or any now known or later developed type that is used to view television programs. Conventionally, CPE are not necessary to decode television program data content that is transmitted by over-the-air systems. CPE may also include hardware and software used to access or download information over a public or privately accessible network such as the Internet. Accordingly, the term CPE also includes that hardware and software necessary to download data content from a privately or publicly accessible network such as the Internet.

An additional benefit of the exemplary embodiments is provided because the categorization data is provided by a trusted third-party. For example, a user may select an entity who has a value system that is believed to be similar to his/her own, so that categorization data, which requires some degree of judgment, e.g., whether a television program includes highly, moderately, or mildly violent, is consistent with the user's perspective. A degree of utility is provided because categorization data includes information that is more descriptive then whether a television program is appropriate for a genderless child of a certain age.

To set discrimination criteria or identify a trusted third-party, any of the exemplary embodiments may offer information to and receive input from a user. This may be done, for example, by using a graphical user interface on a monitor, e.g., as part of a television set, by accessing a web page on the Internet, by navigating through a series of prompts/responses on an automated telephone system, etc.

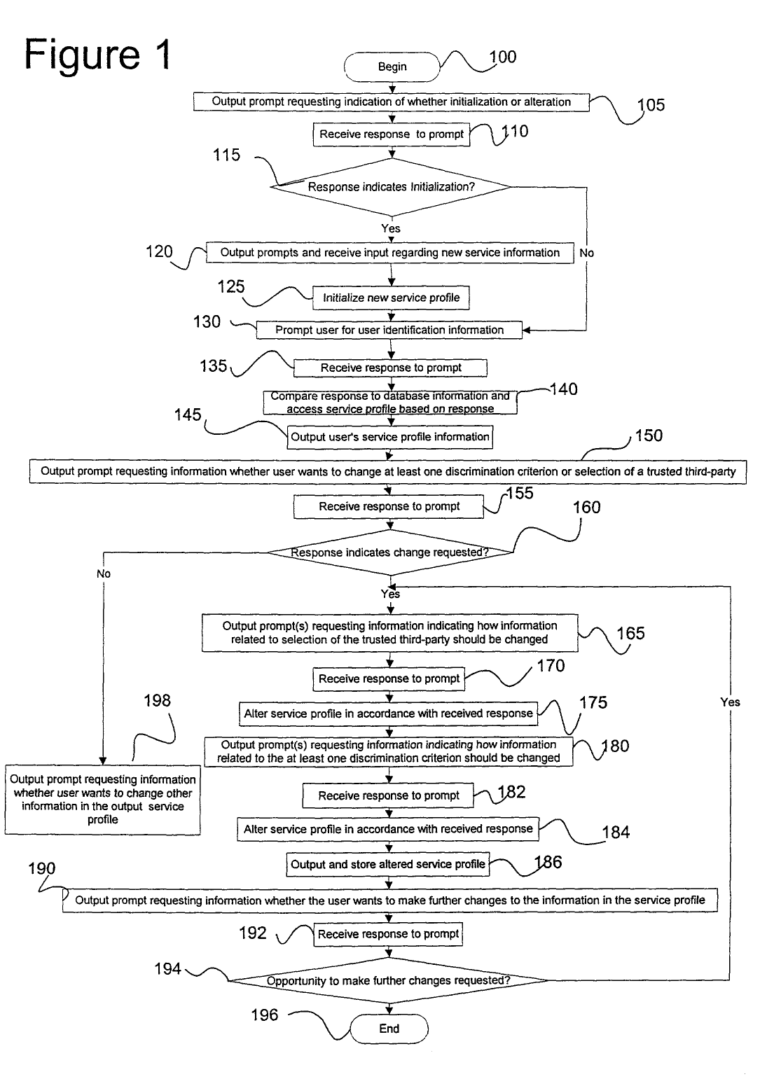

FIG. 1 is a flowchart illustrating one exemplary method of interfacing with a user to set at least one discrimination criterion and/or at least one trusted third-party in accordance with the exemplary embodiments of the invention. As shown in FIG. 1, a method for setting discrimination criteria begins at 100 and control proceeds to 105. At 105, a prompt is output to a user requesting input of information indicating whether the user is initializing a new service profile or whether the user is modifying an existing service profile. Control then proceeds to 110, in which the user's response to the prompt is received. Control then proceeds to 115, in which a determination is made whether the user is initializing a new service profile or the user is modifying an existing user profile.

If the user is modifying an existing service profile, control proceeds to 130. If the user is initializing a new service profile, control proceeds to 120, at which initializing information, e.g., a menu of items, is displayed. The new user is prompted to provide responses to provide information necessary to initialize the service, e.g., identity, password, billing information etc. Control then proceeds to 125, in which the information received from the new user is used to initialize a new service profile. This service profile identifies the new user as a user capable of setting discrimination data and identifying a trusted third-party. It is foreseeable, that the service profile may also identify other users having the capability of setting discrimination data. Such may be the situation when a first user is one parent and a second user is another parent and each parent wants the capability to set or change both discrimination criteria and selection of trusted third parties. Alternatively, such may be the example when a first user is one adult living in a household and a second user is another adult living in that household and each adult is using the exemplary embodiments of the invention to identify data content that is of particular interest to them. Control then proceeds to 130.

At 130, a prompt is output to a user requesting input of the user's identification information. This identification information may be a user ID but may also include a user password. Use of a security mechanism such as a user password may be implemented to control the ability to set discrimination criteria. Such an ability would be particularly useful when the exemplary embodiments of the invention are implemented to control an audience's access to data content that is inappropriate, e.g., a child's access to sexually explicit data content. Control then proceeds to 135, in which input user identification information is received.

Control then proceeds to 140, in which the received input information is compared with a database of user identification information to access the service profile corresponding to the user identification information. A service profile includes user identification information, at least one discrimination criterion and identification of at least one trusted third-party providing categorization data. It should be appreciated that, if a new service profile has just been initialized in 125, no information, or default information, relating to discrimination criteria and identification of a trusted third-party may be contained in the user's service profile.

Control then proceeds to 145, at which information included in the service profile corresponding to the user identification information is output to the user and control proceeds to 150. At 150, a prompt is output to the user requesting information indicating whether the user would like to alter information associated with at least one discrimination criterion or selection of a trusted third-party contained in the service profile. Control then proceeds to 155, at which that information is received and control proceeds to 160. At 160, a determination is made whether the user would like to alter the information relating to the discrimination criteria and/or selection of a trusted third-party within the service profile information. If not, control proceeds to 198, at which one or more prompts are output to the user requesting information indicating whether other actions, e.g., altering billing data, are requested by the user. If so, control proceeds to actions that provide a menu of options for further actions other than altering discrimination criteria and/or a trusted third-party. If 160 determines that the user would like to alter information relating to the discrimination criteria and/or selection of a trusted third-party, control proceeds to 165.

At 165, one or more prompts are output to the user requesting information about how the information related to the trusted third-party should be changed. Control then proceeds to 170, in which that information input by the user in response to the one or more prompts is received. Control then proceeds to 175, at which the service profile is altered in accordance with the received information. Control then proceeds to 180, at which one or more prompts are output to the user requesting information about how the information related to the discrimination criteria should be changed. Control then proceeds to 182, at which that information input by the user in response to the one or more prompts are received. Control then proceeds to 184, at which the service profile is altered in accordance with the received information and the altered service profile is stored. Control then proceeds to 186, at which the service profile, altered in accordance with any alterations requested at 165-184, is output for review by the user. Control then proceeds to 190, at which a prompt is output to the user requesting information indicating whether the user would like to make additional changes. Control then proceeds to 192, at which a response to the prompt is received. Control then proceeds to 194, at which a determination is made whether the response indicates that the user has requested the opportunity to make additional changes. If the response indicates that the opportunity to make additional changes has been requested, control returns to 165. If the response indicates that the opportunity to make additional changes has been declined, control proceeds to 196, at which the method ends.

The one or more prompts provided at 180 may provide the user with information regarding a plurality of optional categories of data content to exclude or include such as “professional wrestling” or “arts and entertainment”, “history”, “cooking”, “Sesame Street®”, etc. Also, the user may be provided with information regarding a plurality of optional characteristics of data content to include or exclude. For example, negative program qualities may include violence, sex, profanity, antisocial behavior, dangerous behavior and horror. Also, positive program qualities may include educational value, artistic quality, diversity (e.g., gender, racial, ethnic, religious), family values, socially redeeming value and core human values such as trust, tolerance, honesty, and justice, etc.

As with negative program qualities, identification of the significance of each positive program quality can be designated as well. It is foreseeable that each discrimination criterion can be assigned a significance by the user. For example, although a user may be interested in television programs about both cooking and gardening, that user may be more interested in television programs about cooking than programs about gardening. Therefore, following receipt of the discrimination criteria input by the user, the user may be provided with the option to either rank the selected discrimination criteria in order of importance or to assign a level of importance, e.g., a numerical value from 1-10, to each of the selected discrimination criteria.

It is also foreseeable that a user may be prompted to provide information indicating what type of data the discrimination criteria should be used to selectively present or sort. For example, a user may be prompted to provide information about whether their interest in murder mysteries, as indicated by their selection of a murder mystery discrimination criterion in their service profile, should be used selectively present or sort both audio-visual data, such as a television show, and text data, such as downloadable books and other publications.

Additionally, it is forseeable that a user may be prompted to provide information indicating whether he/she wants to limit an amount of data content over a period of time. For example, a user who is a parent may select discrimination criteria that is directed at providing suitable data content for a ten year old boy. However, the parent wants to allow the boy a maximum of two hours per week of viewing television or a particular type of television show, e.g., action cartoon shows with a moderate level of violent activity. The parent, as the user, may be prompted to provide a maximum limit on the amount of data content or data content that meets specific discrimination criteria.

Also, it is foreseeable that a user may be prompted to provide schedule information that indicates when selected discrimination criteria should be used to selectively present or sort data content. For example, a parent, as a user, may want their child to only watch non-violent educational television programs during the day because, for example, the child is only supervised by a babysitter. However, in the evening, the parent wants this limitation to be removed because the family views television programs together. Therefore, a user may be prompted to provide a specific schedule of when specific discrimination criterion should be used to selectively present or sort data content.

The one or more prompts provided at 165 may provide the user with information regarding a plurality of optional trusted third-parties to select. This information may include a brief summary or description of the third-parties including, for example, a description of their areas of expertise, the identity of individuals who are reviewing data content and providing categorization data, information about the values or goals of the third-parties, a list of the types of categorization data provided by the third-parties (for example, whether or not a particular religious group provides categorization data regarding sexually explicit content or whether or not the Smithsonian Institution provides categorization data regarding Ancient Cultures).

In accordance with the first exemplary embodiment of the invention, selective data content presentation is performed by selectively enabling output of broadcast data content received at CPE. The selectively enabled output of the data content is performed based on an analysis of categorization data provided by a trusted third-party and discrimination criteria selected by a user.

In accordance with first through fourth exemplary embodiments of the invention, the categorization data provided by the trusted third-party is schedule-based. This schedule-based categorization data provides information about broadcast data content that has been or will be transmitted and received (first exemplary embodiment), transmitted (second exemplary embodiment) or is transmittable (third exemplary embodiment) during time periods included in the schedule.

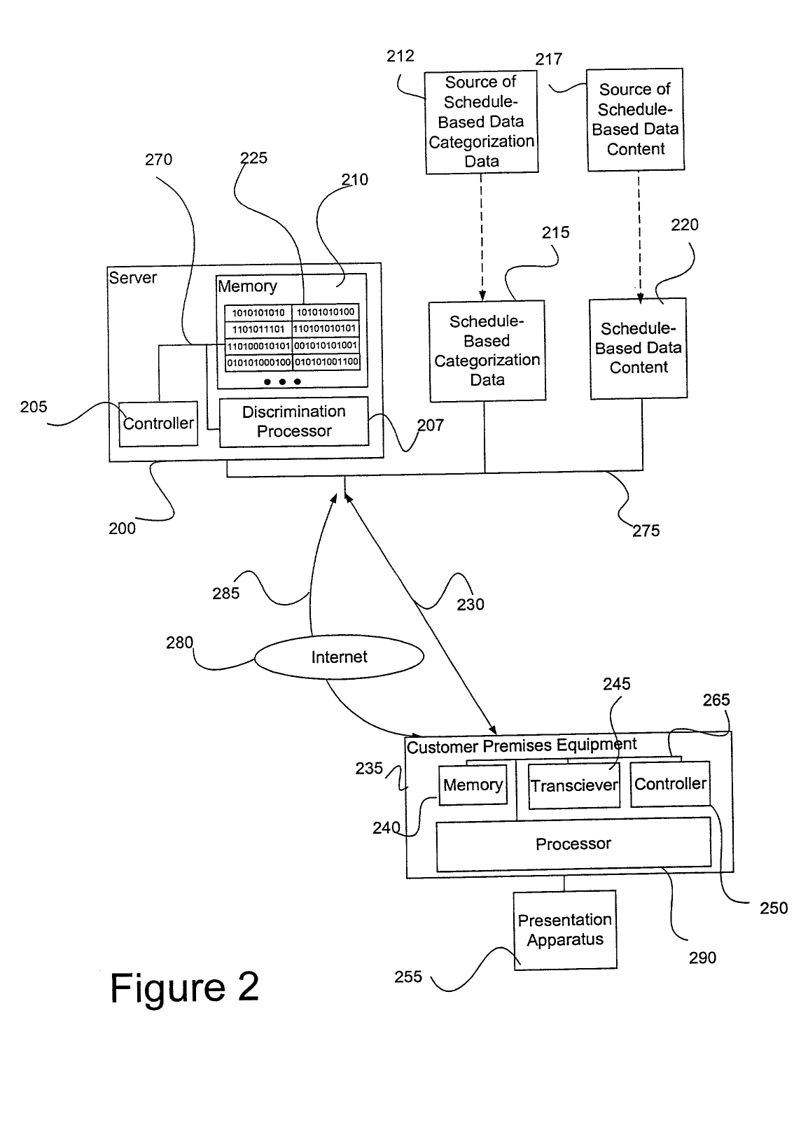

FIG. 2 is a block diagram illustrating one exemplary system architecture that may implement the first exemplary embodiment of the invention. As illustrated in FIG. 2, a system for selectively presenting broadcast data content that is coupled to CPE 235, which is coupled to a presentation apparatus 255. The system is also coupled to a source of schedule-based categorization data 212 and a source of schedule-based data content 217. The source of schedule-based categorization data 212 may be the trusted third-party selected by the user or may be, for example, an intermediary that organizes the categorization data provided by the trusted third-party into a schedule-based format.

The system may include a server 200 that may include a controller 205, a discrimination processor 207 and a memory 210 coupled together by a data/control bus 270. The memory 210 may include a database 225 that includes service profile information for at least one, and potentially a plurality of, user service profile(s). The database 225 may also contain the schedule-based categorization data provided by the source 212. Alternatively the schedule-based categorization data may be stored in a separate database (not shown) or in a separate memory (not shown). The schedule-based data content 220 provided by the source 217 may be input to and stored in memory 225 using data path 275. Alternatively, the schedule-based data content 220 may be stored in a separate memory (not shown).

The controller 205 controls the discrimination processor to determine what data content 220 should be presented to an audience on the presentation apparatus 255 based on the discrimination criteria in the service profile stored in the database 225 and the categorization data 215 provided by the trusted third-party selected by the user. Based on this determination, the discrimination processor formulates index data, which is transmitted to the CPE 235 along with the schedule-based data content 220. The transmission may be performed over either data/control path 230 or over path 285, which may or may not include the a public network such as the Internet 280.

Within the CPE 235, the controller 250 controls the memory 240, the transceiver 245 and the processor 290 using the control/data bus 265, which couples the memory 240, transceiver 245, the processor 290 and the controller 250. The CPE 235 receives the index data and the schedule-based data content 220 via the transceiver 245, and both the index data and the schedule-based data content 220 are stored in memory 240 under direction by the controller 250. Alternatively, the index data may be stored in a memory that is separate (not shown) from a memory that stores the schedule-based data content 220. Under the direction of the controller 250, the processor 290 formulates a presentation index based on comparison between the received schedule-based data content 220 and the index data.

The processor 290 then selectively enables presentation of the schedule-based data content 220 that meets the user's selected discrimination criterion on the presentation apparatus 255 based on the index data. Additionally, the controller 250 controls the processor 290 to output the formulated presentation index to the presentation apparatus so that an audience can determine what data content is available for presentation.

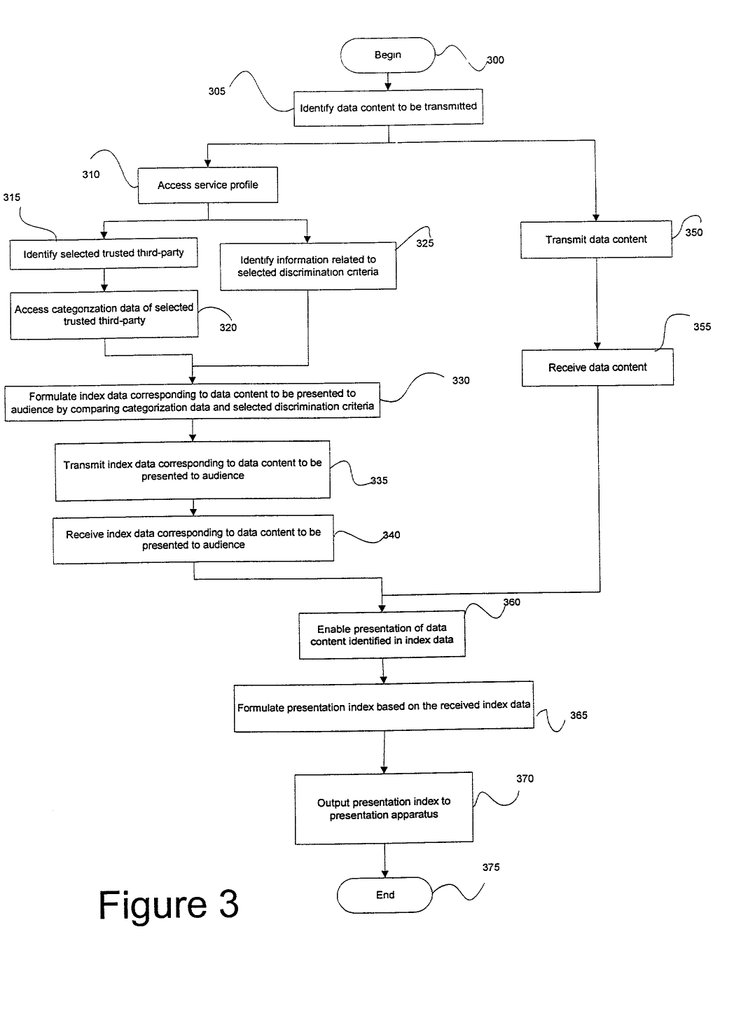

FIG. 3 is a flowchart illustrating one exemplary method for implementing the first exemplary embodiment of the invention. As illustrated in FIG. 3, the method begins at 300, in which control proceeds to 305. At 305, the data content to be transmitted is identified. Control then proceeds to 310, at which a user's service profile is accessed. Control then proceeds to 315, at which the trusted third-party selected by the user is identified. Control then proceeds to 320, at which the categorization data provided by the selected, trusted third-party is accessed. The actions performed at325 may be performed simultaneously with the actions performed at 315-320, or may be performed subsequently or prior to them.

At 325, information related to and including selected discrimination criteria is identified and control proceeds to 330. At 330, index data corresponding to data content to be presented to an audience is formulated by comparing categorization data provided by the selected, trusted-third-party and the selected discrimination criteria in the service profile. Control then proceeds to 335, at which the formulated index data is transmitted to CPE. Control then proceeds to 340, at which the index data is received at the CPE. The actions performed at 350 and 355 may be performed simultaneously with the actions performed at 310-340. Alternatively, the actions performed at 350 and 355 may be performed either prior or subsequent to performance of the actions performed at 310-340.

At 350, data content, for example, data associated with a number of television shows being broadcast at the same time, is transmitted from, for example, a head end. Control then proceeds to 365, at which the data content transmitted at 350 is received, for example, by CPE. Control then proceeds to 360, at which presentation of all or part of that data content is enabled based on the index data. Control then proceeds to 365, at which a presentation index is formulated based on the received index data. Control then proceeds to 370, at which the presentation index is output, for example, to an apparatus. Control then proceeds to 375, at which the method ends.

It should be appreciated that the methods illustrated in FIGS. 3, 5, 7 and 9 are performed periodically, for example, when television program information transmitted as EPG data to a television changes, or when a tuner included in a presentation apparatus is tuned to a channel over which a program that does not meet a user's discrimination criterion is being transmitted. Regardless of the conditions that trigger the illustrated methods, FIGS. 3, 5, 7 and 9 are flow charts that represent the manner, in which that selective data content presentation and/or sorting is performed in accordance with the exemplary embodiments.

Also, it is foreseeable that a user may be prompted to provide schedule information in his/her service profile that indicates when categorization data provided by a selected trusted third-party should be used to selectively present or sort data content. For example, a parent, as a user, may want their child's television viewing during the day to be based on categorization data provided by a trusted third-party that is an expert in child development. However, the parent may also want family viewing during a portion of the evening hours to be based on categorization data provided by a trusted third-party that is expert in news reporting, e.g., The Economist. Therefore, a user may be prompted to provide a specific schedule of when categorization data provided by specified trusted third-parties should be used to selectively present or sort data content.

In accordance with the second exemplary embodiment of the invention, selective data content presentation is performed by selectively enabling reception of broadcast data content at CPE. The selectively enabled reception of the broadcast data is performed based on an analysis of categorization data provided by a trusted third-party and discrimination criteria.

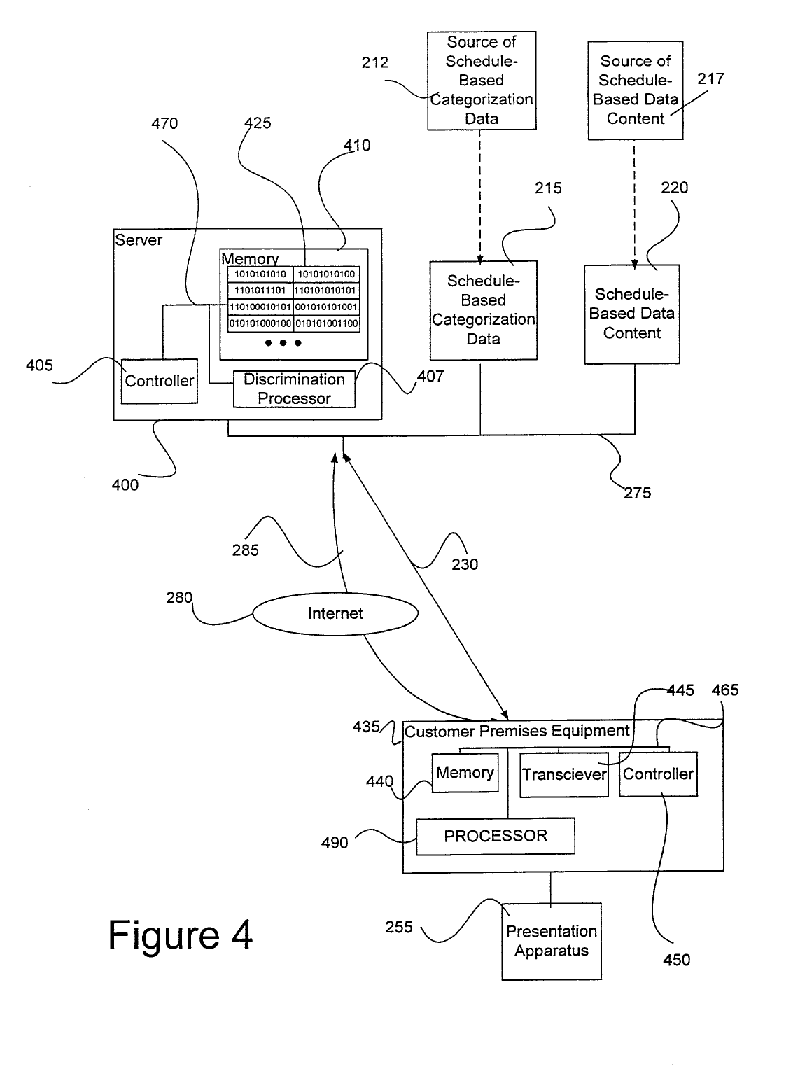

FIG. 4 is a block diagram illustrating one exemplary system architecture that may implement the second exemplary embodiment of the invention. Similar to FIG. 2, FIG. 4 illustrates a system for selectively presenting broadcast data content that is coupled to CPE 435, which is coupled to a presentation apparatus 255. All elements having identical numbering in both FIGS. 2 and 4 are identical and operate in an identical manner. Therefore, description of identically numbered elements is eliminated for conciseness.

The system is also coupled to a source of schedule-based categorization data 212 and a source of schedule-based data content 217. The system may include a server 400 that may include a controller 405, a discrimination processor 407 and a memory 410 coupled together by a data/control bus 470. The memory 410 may include a database 425 that includes service profile information for at least one, and potentially a plurality of, user service profile(s). The database 425 may also contain the schedule-based categorization data provided by the source 212. Alternatively the schedule-based categorization data may be stored in a separate database (not shown) or in a separate memory (not shown). The schedule-based data content 220 provided by the source 217 may be input to and stored in memory 425 using data path 275. Alternatively, the schedule-based data content 220 may be stored in a separate memory (not shown).

The controller 405 controls the discrimination processor to determine what data content 220 should be presented to an audience on the presentation apparatus 255 based on the discrimination criteria in the service profile stored in the database 425 and the categorization data 215 provided by the trusted third-party. Based on this determination, the discrimination processor formulates index data, which is transmitted to the CPE 435 along with the schedule-based data content 220. The transmission may be performed over either data/control path 230 or over path 285 that may or may not include a public network such as the Internet 280.

Within the CPE 435, the controller 450 controls the memory 440, the transceiver 445 and the processor 490 via the control/data bus 465, which couples the memory 440, transceiver 445, the processor 490 and the controller 450. The CPE 435 receives the index data via the transceiver 445 and stores the index data in memory 440 under direction of the controller 450. Also under the direction of the controller 450, the processor 490 selectively enables reception of the schedule-based data content 220 by the transceiver based on the index data stored in the memory 440. The portion of the schedule-based data content 220 that meets the discrimination criteria contained in the relevant portion of the service profile is received by the transceiver and stored in memory 440 under direction by the controller 450. Also under the direction of the controller 450, the processor 490 formulates a presentation index based on the received index data. Alternatively, the index data may be stored in a memory that is separate (not shown) from a memory that stores the schedule-based data content 220.

The controller 450 controls the processor 490 to output the formulated presentation index to the presentation apparatus so that an audience can determine what data content is available for presentation.

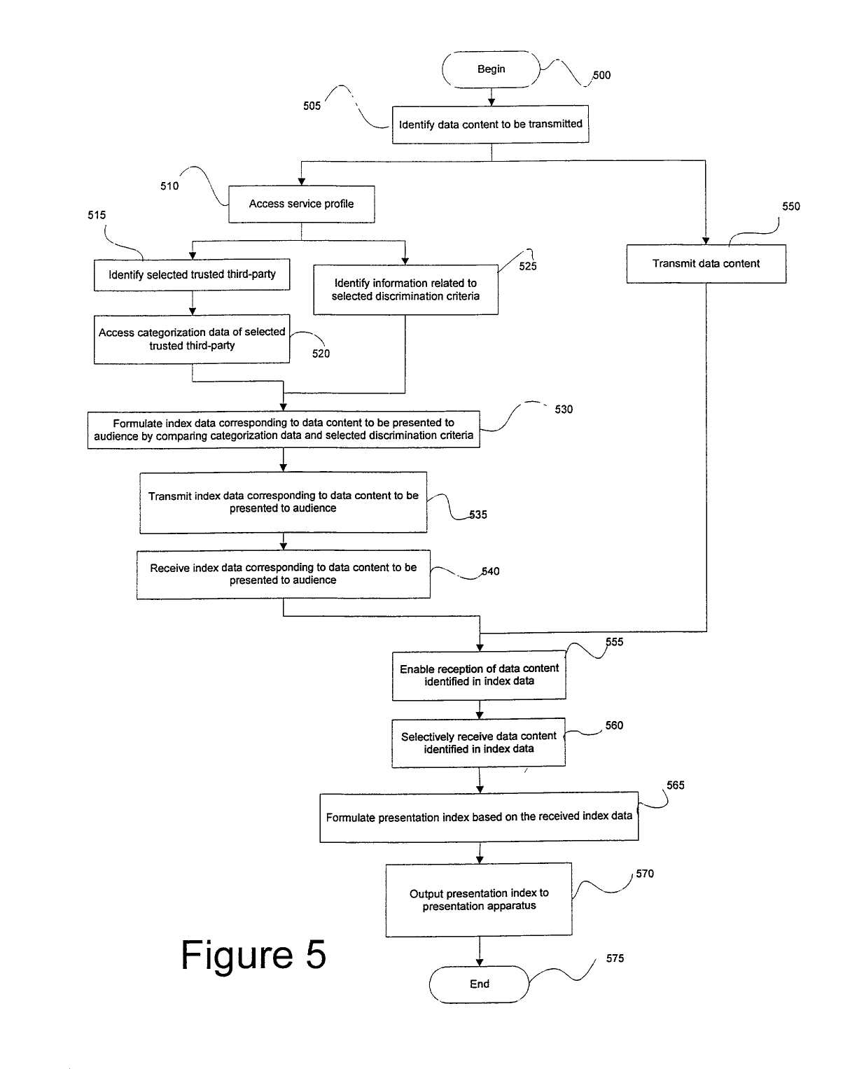

FIG. 5 is a flowchart illustrating one exemplary method for implementing the second exemplary embodiment of the invention. As illustrated in FIG. 5, the method begins at 500, in which control proceeds to 505. At 505, the data content to be transmitted is identified. Control then proceeds to 510, at which a user's service profile is accessed. Control then proceeds to 515, at which the trusted third-party selected by the user is identified. Control then proceeds to 520, at which the categorization data provided by the selected, trusted third-party is accessed. The actions performed at 525 may be performed simultaneously with the actions performed at 515-520, or may be performed subsequently or prior to them.

At 525, information related to and including selected discrimination criteria is identified and control proceeds to 530. At 530, index data corresponding to data content to be presented to an audience is formulated by comparing categorization data provided by the selected, trusted-third-party and the selected discrimination criteria in the service profile. Control then proceeds to 535, at which the formulated index data is transmitted to CPE. Control then proceeds to 540, at which the index data is received at the CPE. The actions performed at 550 may be performed simultaneously with the actions performed at 510-540. Alternatively, the actions performed at 550 may be performed either prior or subsequent to performance of the actions performed at 510-540.

At 550, data content, for example, data associated with a number of television shows being broadcast at the same time, is transmitted from, for example, a head end. Control then proceeds to 555, at which reception of any portion of the transmitted data is enabled based on whether that portion of the transmitted data meets the discrimination criteria contained the user's service profile. Control then proceeds to 560, at which selective reception of those portions of the transmitted data is performed based on the received index data. Control then proceeds to 565, at which a presentation index is formulated based on the received index data. Control then proceeds to 570, at which the presentation index is output, for example, to a presentation apparatus. Control then proceeds to 575, at which the method ends.

In accordance with the third exemplary embodiment of the invention, selective data content presentation is performed by selectively enabling transmission of broadcast data content to CPE, by selectively enabling receipt of transmitted data content by the CPE or by selectively enabling display of received data content.

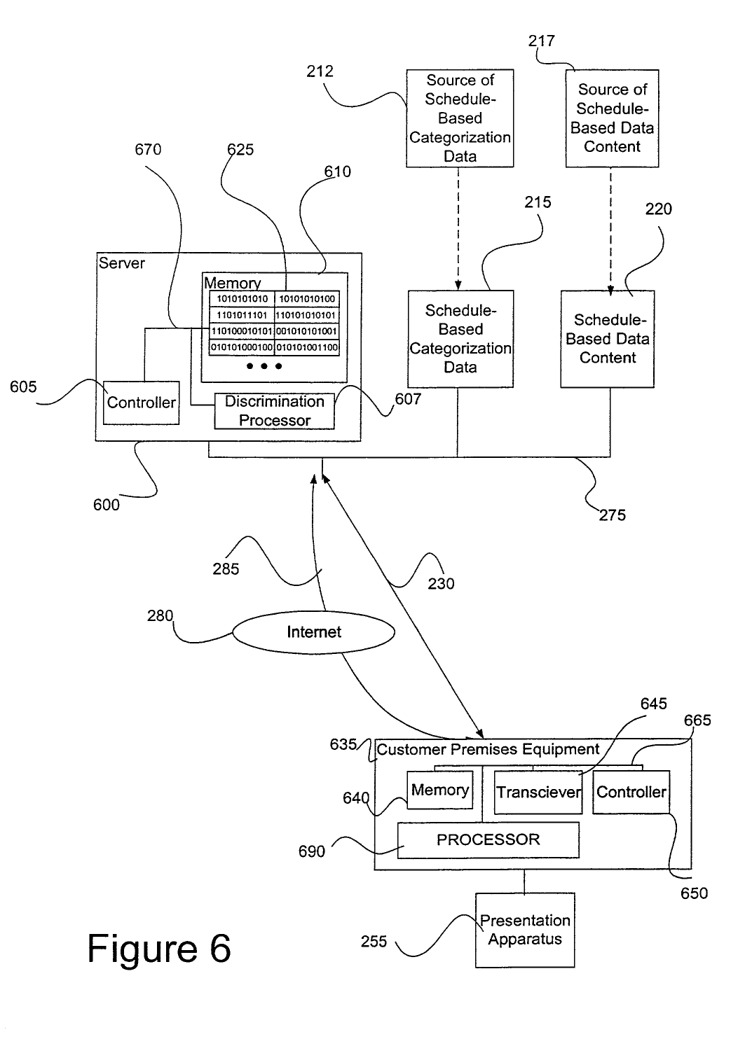

FIG. 6 is a block diagram illustrating one exemplary system architecture that may implement the third exemplary embodiment of the invention. Similar to FIGS. 2 and 4, FIG. 6 illustrates a system for selectively presenting broadcast data content that is coupled to CPE 635, which is coupled to a presentation apparatus 255. All elements having identical numbering in all of FIGS. 2, 4 and 6 are identical and operate in an identical manner. Therefore, description of identically numbered elements is eliminated for conciseness.

The system is also coupled to a source of schedule-based categorization data 212 and a source of schedule-based data content 217. The system may include a server 600 that may include a controller 605, a discrimination processor 607 and a memory 610 coupled together by a data/control bus 670. The memory 610 may include a database 625 that includes service profile information for at least one, and potentially a plurality of, user service profile(s). The database 625 may also contain the schedule-based categorization data provided by the source 212. Alternatively the schedule-based categorization data may be stored in a separate database (not shown) or in a separate memory (not shown). The schedule-based data content 220 provided by the source 217 may be input to and stored in memory 625 using data link 275. Alternatively, the schedule-based data content 220 may be stored in a separate memory (not shown).

The controller 605 controls the discrimination processor to determine what data content 220 should be presented to an audience on the presentation apparatus 255 based on the discrimination criteria in the service profile stored in the database 625 and the categorization data 215 provided by the trusted third-party. Based on this determination, the discrimination processor formulates index data, which is transmitted to the CPE 635. The index data is also used by the controller 605 to control selective transmission of the schedule-based data content 220. The portion of the schedule-based data content 220 that meets the discrimination criteria contained in the relevant portion of the service profile is transmitted to the CPE 635 under direction of the controller 605. That is, only that portion or portions of the data content 220 that meet the user's discrimination criteria stored in the user's service profile are transmitted to the CPE 635. This transmission of the portion of the data content 220 meeting the discrimination criteria may be performed over either data/control path 230 or over path 285 that may or may not include a public network such as the Internet 280.

Within the CPE 635, the controller 650 controls the memory 640, the transceiver 645 and the processor 690 via the control/data bus 665, which couples the memory 640, transceiver 645, the processor 690 and the controller 650. The CPE 635 receives the index data via the transceiver 645 and stores the index data in memory 640 under direction of the controller 650. Alternatively, the index data may be stored in a memory that is separate (not shown) from a memory that stores the schedule-based data content 220. Also under the direction of the controller 650, the processor 690 receives the schedule based data content 220 that has been selectively transmitted under the control of controller 605 to the transceiver 645. Under the direction of the controller 650, the processor 690 formulates a presentation index based on the received index data stored in the memory 640. The controller 650 controls the processor 690 to output the formulated presentation index to the presentation apparatus so that an audience can determine what data content is available for presentation.

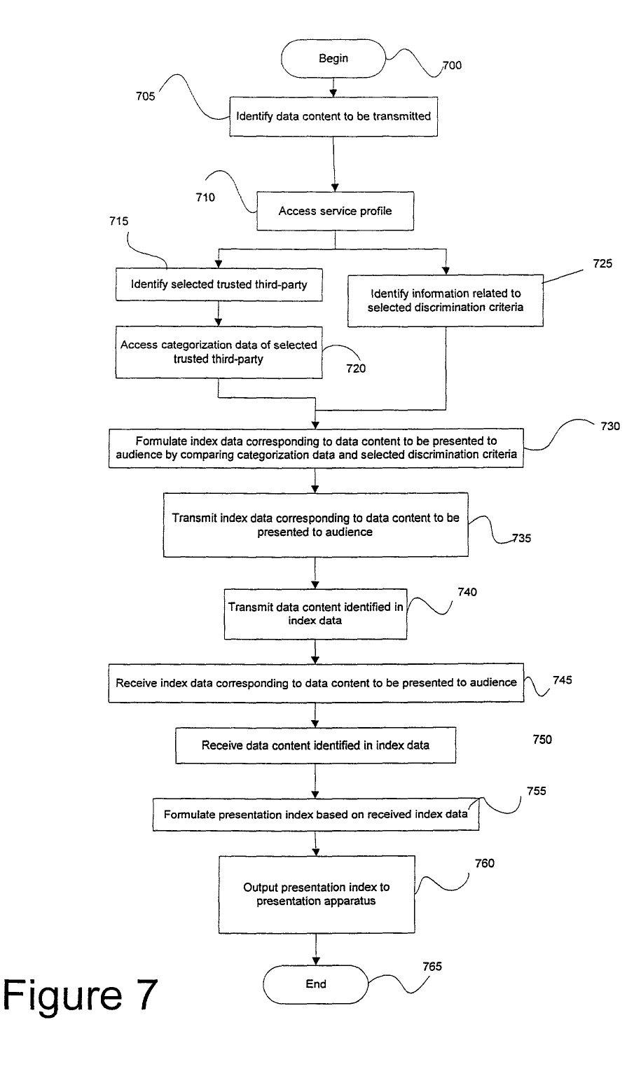

FIG. 7 is a flowchart illustrating one exemplary method for implementing the third exemplary embodiment of the invention. As illustrated in FIG. 7, the method begins at 700, at which control proceeds to 705. At 705, the data content to be transmitted is identified. Control then proceeds to 710, at which a user's service profile is accessed. Control then proceeds to 715, at which the trusted third-party selected by the user is identified. Control then proceeds to 720, at which the categorization data provided by the selected, trusted third-party is accessed. The actions performed at 725 may be performed simultaneously with the actions performed at 715-720, or may be performed subsequently or prior to them.

At 725, information related to and including selected discrimination criteria is identified and control proceeds to 730. At 730, index data corresponding to data content to be presented to an audience is formulated by comparing categorization data provided by the selected, trusted-third-party and the selected discrimination criteria in the service profile. Control then proceeds to 735, at which the formulated index data is transmitted to, for example, the user's CPE. Control then proceeds to 740, at which that portion, if any, of the data content 220 identified in the index data as meeting the selected discrimination criteria contained in the user's service profile is transmitted to, for example, the user's CPE. Control then proceeds to 745, at which the index data is received at the user's CPE and control proceeds to 750. At 750, the transmitted data content is received at the user's CPE. Control then proceeds to 755. At 755, a presentation index is formulated based on the received index data. Control then proceeds to 760, at which the presentation index is output, for example, to a presentation apparatus. Control then proceeds to 765, at which the method ends.

In accordance with the fourth exemplary embodiment of the invention, broadcast data are sorted and associated labels, e.g., titles, are presented in a specialized format that indicates a level of appropriateness. It should be understood that the specialized format is formulated based on the specific discrimination criteria contained in a user's service profile. For example, portions of data content may be listed in a descending or ascending order to indicate appropriateness to one or more audiences at a customer premises. Alternatively, or in addition, labels associated with data content may be presented to the one or more audiences with tags indicating the relative appropriateness of the data content to a particular audience(s). Regardless of the specialized format, the display of the labels in the format is based on the schedule-based categorization data provided by a trusted third-party and based on discrimination criteria provided by a user.

This specialized format of labels may show all available data content sorted to indicate which data content is most appropriate for the audience. Such a specially formatted presentation index may then be made available for review by an audience so that the audience may select data content for presentation that is either appropriate or is most appropriate from amongst available the data content.

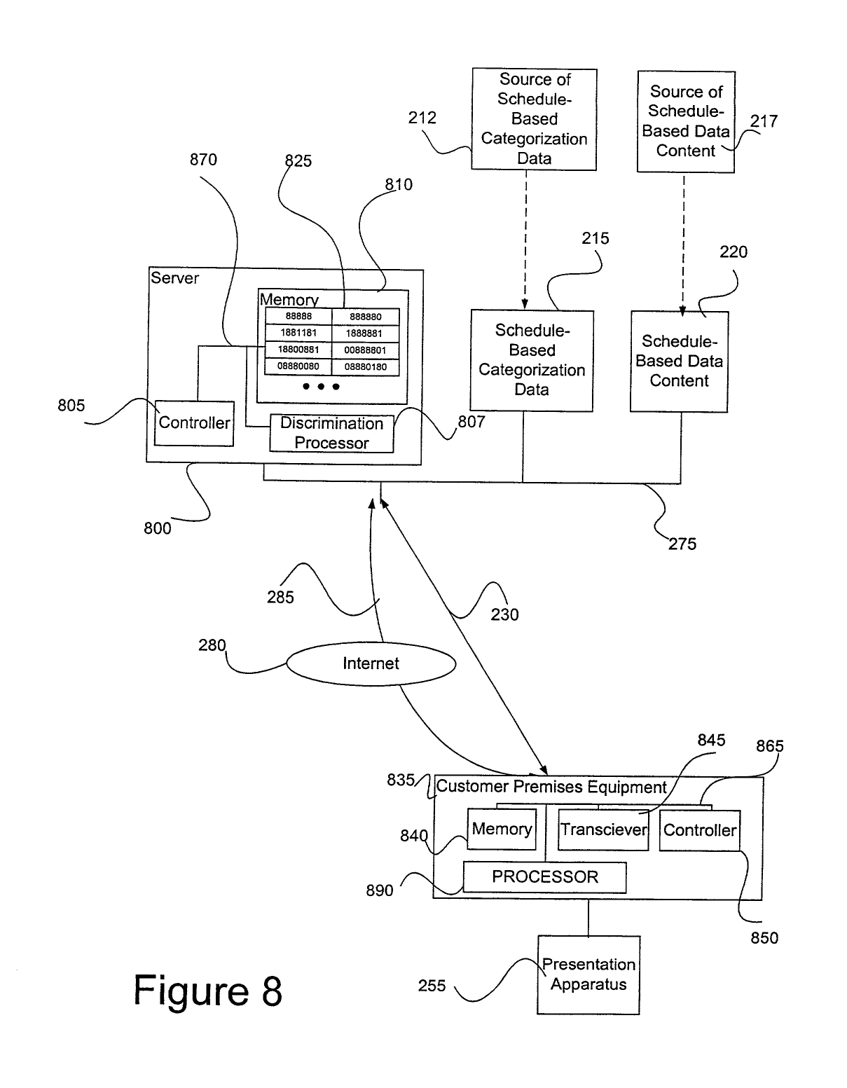

FIG. 8 is a block diagram illustrating one exemplary system architecture that may implement the fourth exemplary embodiment of the invention. FIG. 8 illustrates a system for sorting broadcast data content that is coupled to CPE 835, which is coupled to a presentation apparatus 255. All elements having identical numbering in all of FIGS. 2, 4, 6 and 8 are identical and operate in an identical manner. Therefore, description of identically numbered elements is eliminated for conciseness.

The system is also coupled to a source of schedule-based categorization data 212 and a source of schedule-based data content 217. The system may include a controller 805, a discrimination processor 807 and a memory 810 coupled together by a data/control bus 870. The memory 810 may include a database 825 that includes service profile information for at least one, and potentially a plurality of, user service profile(s). The database 825 may also contain the schedule-based categorization data provided by the source 212. Alternatively, the schedule-based categorization data may be stored in a separate database (not shown) or in a separate memory (not shown). The schedule-based data content 220 provided by the source 217 may be input to and stored in memory 825 using data link 275. Alternatively, the schedule-based data content 220 may be stored in a separate memory (not shown).

The controller 805 controls the discrimination processor 807 to determine how labels corresponding to particular portions of data content 220, e.g., television program titles, should be presented to an audience on the presentation apparatus 255 based on the discrimination criteria in the service profile and the categorization data 215 provided by the trusted third-party. Based on this determination, the discrimination processor 807 formulates index data in a specialized format, which is transmitted to the CPE 835. All the schedule-based data content 220 is transmitted to the CPE 835 under direction of the controller 805. This transmission of the data content 220 may be performed over either data/control path 230 or over path 285 that may or may not include a public network such as the Internet 280.

Within the CPE 835, the controller 850 controls the memory 840, the transceiver 845 and the processor 890 using the control/data bus 865, which couples the memory 840, transceiver 845, the processor 890 and the controller 850. The CPE 835 receives the index data in the specialized format via the transceiver 845 and stores the index data in memory 840 under direction of the controller 850. Alternatively, the specially formatted index data may be stored in a memory that is separate (not shown) from a memory that stores the schedule-based data content 220. Also, under the direction of the controller 850, the processor 890 receives the schedule based data content 220 that has been transmitted under the control of controller 805 to the transceiver 845. Under the direction of the controller 850, the processor 890 formulates a specially formatted presentation index based on the specially formatted index data stored in the memory 840. The controller 850 controls the processor 890 to output the specially formulated presentation index to the presentation apparatus so that an audience can determine what data content is available and is most appropriate.

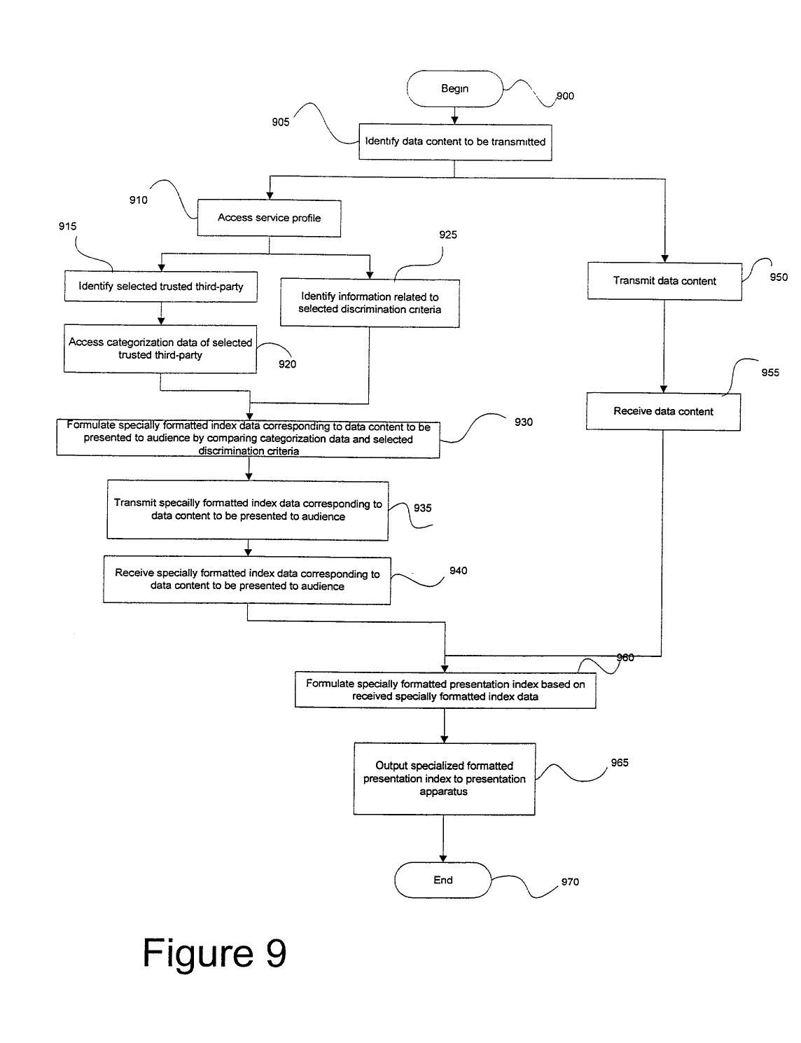

FIG. 9 is a flowchart illustrating one exemplary method for implementing the fourth exemplary embodiment of the invention. As illustrated in FIG. 9, the method begins at 900, at which control proceeds to 905. In 905, the data content to be transmitted is identified. Control then proceeds to 910, at which a user's service profile is accessed. Control then proceeds to 915, at which the trusted third-party selected by the user is identified. Control then proceeds to 920, at which the categorization data provided by the selected, trusted third-party is accessed. The actions performed at 925 may be performed simultaneously with the actions performed at 915-920, or may be performed subsequently or prior to them.

At 925, information related to and including selected discrimination criteria is identified and control proceeds to 930. At 930, specially formatted index data corresponding to data content to be presented to an audience is formulated by comparing categorization data provided by the selected, trusted-third-party and the selected discrimination criteria in the service profile. This specially formatted index data indicates which data content incorporated in data content 220 is most appropriate for presentation to at least one audience based on the categorization data and the discrimination criteria. Control then proceeds to 935, at which the specially formulated index data is transmitted to, for example, the user's CPE. Control then proceeds to 940, at which the specially formatted index data is received at the user's CPE and control proceeds to 950.

The actions performed at 950 and 955 may be performed simultaneously with the actions performed at 910-940. Alternatively, the actions performed at 950 and 955 may be performed either prior or subsequent to performance of the actions performed at 910-940.

At 950, data content, for example, data associated with a number of television shows being broadcast at the same time, is transmitted from, for example, a head end. Control then proceeds to 955, at which the data content transmitted at 950 is received, for example, by CPE. Control then proceeds to 960, at which a specially formatted presentation index is formulated based on the index data. Control then proceeds to 965, at which the specially formatted presentation index is output, for example, to a presentation apparatus. Control then proceeds to 970, at which the method ends.

As explained above, the exemplary embodiments of the invention may be used to perform schedule-based discrimination and provide information that may be used in conjunction with schedule-based EPG data that is transmitted to a CPE and indicates a schedule of television program transmission to that CPE. For example, for each television program, EPG data can include the channel over which that television program is transmitted (i.e., the channel number); the time of day at which the television program is transmitted (e.g., start time); the duration of the television program (i.e., program length); the name of the television program; the type of the television program (e.g., movie, comedy, special, weekly series, etc.); the genre of the television program (e.g., drama, comedy, sporting event, action, etc); and a description of the television program (e.g., the names of the starring performers, a brief summary of the subject matter of the television program, etc.).

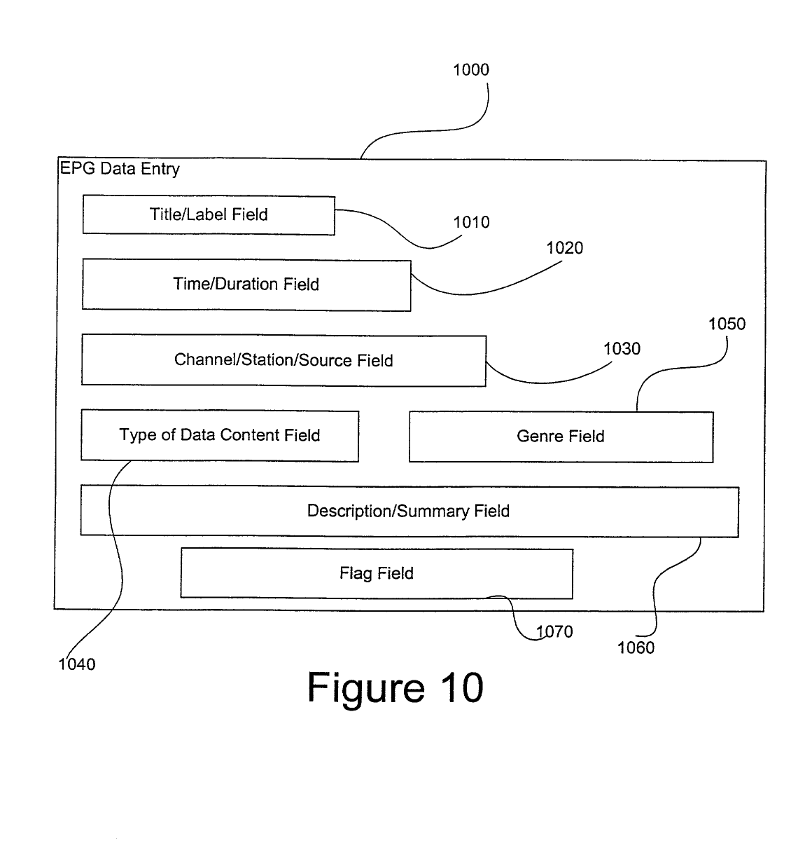

By implementing the exemplary embodiments, the above-described EPG data can be manipulated based on the discrimination criteria set by a user(s) and categorization data provided by a trusted third-party. FIG. 10 illustrates one example of a graphical user interface generated by the first through fourth exemplary embodiments of the invention. As shown in FIG. 10, an EPG data entry 1000 may include a title field 1010 indicating the title of a particular television program, a time field 1020 indicating when the program is transmitted to the CPE and its duration and/or when the program is available for view, a channel field 1030 indicating the channel or station showing the program, or the source of the program, a type field 1040 indicating the type of data content, e.g., a television program and the television program (e.g., movie, news, special, weekly series, etc.), a genre field 1050 indicating the genre of the data content (e.g., drama, comedy, sporting event, action, etc); a description of the television program 1060 (e.g., the names of the starring performers, a brief summary of the subject matter of the television program, etc.). Additionally, EPG data entry 1000 may include at least one tag 1070, that includes an indication of whether a certain audience, e.g., mother Jane Doe, father John Doe, or their children Jim and Janet Doe, would find a program particularly interesting.

In accordance with the fourth exemplary embodiment, it is foreseeable that the method and architecture used to provide the specially formatted presentation index of data content labels may show data sorted by appropriateness but, also, only data content that has been determined to be of a minimum-level of appropriateness. Thus, it should be appreciated that the fourth exemplary embodiment of the invention may be combined with any of the first through third exemplary embodiments of the invention. Additionally, it should be appreciated that the fourth exemplary embodiment may be used to provide specially formatted presentation index for data content that is not schedule-based. Accordingly, aspects of the fourth exemplary embodiment can be combined with aspects of the fifth exemplary embodiment explained below.

In accordance with the fifth exemplary embodiment of the invention, data content is selectively presented based on categorization data provided by a trusted third-party and based on discrimination criteria provided by a user. However, in the fifth exemplary embodiment, the data content is not necessarily schedule-based. Rather, data content may be, for example, text, graphics or multi-media data downloaded from the Internet. With increased access to the Internet through home computers and web-based television, there is an increased amount of data to select from and sort through for review by one's self or, for example, one's children, students, patients, wards, charges, etc. The fifth exemplary embodiment of the invention allows a user to select a trusted third-party to supply categorization data corresponding to such downloadable data content.

A significant benefit of the fifth exemplary embodiment over conventional search engine technology is that a user is unaware of how a search engine provides results for a data content information search. Additionally, nothing is known about the party providing the results to a conventional data content query. Moreover, there is no conventional way to selectively enable exposure to data content based on a perceived quality of that data content determined by a trusted third-party.

For example, although web-sites like www.amazon.com provide characterizations of text content, i.e., books, those books are not downloadable from that web-site and the user is not allowed to select a “third” party to make a determination of quality. That is, the party providing information about a book is the bookseller, i.e., a first party, is providing critical information to a would-be customer, i.e., a second party. In distinction, the exemplary embodiments provide critical information provided by a third party, who has been selected to act as a proxy for a user in determining data content quality. The fifth embodiment of the invention allows a user to receive categorization data from a trusted third-party. By allowing the user to select a trusted third-party, the user should be provided with better information. This is because, theoretically, a party that lacks a monetary or similar interest in whether an audience is exposed to data content will provide the most unbiased categorization data. This is different from such companies like www.amazon.com, which have an interest in providing a favorable characterization of a book, so as to promote a sale.

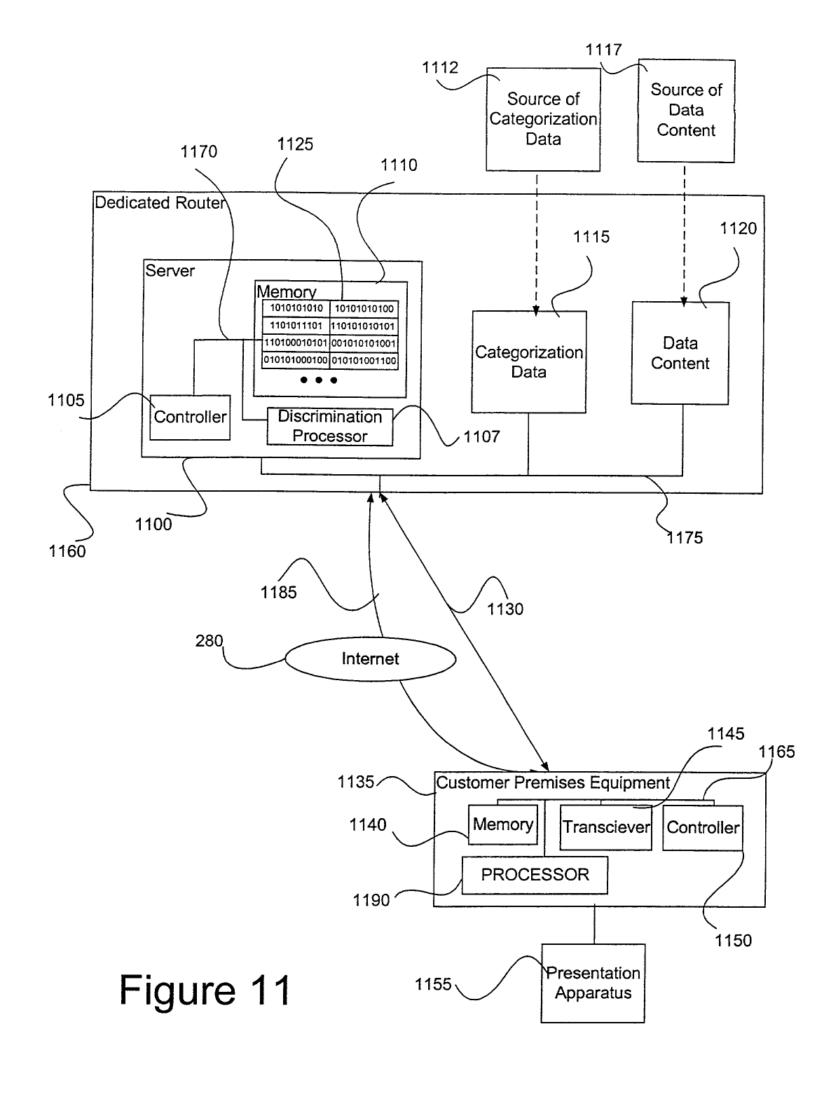

FIG. 11 is a block diagram illustrating one exemplary system architecture that may implement the fifth exemplary embodiment of the invention. As illustrated in FIG. 11, a system for selectively presenting data content includes a dedicated router 1160 coupled to CPE 1135, which is coupled to a presentation apparatus 1155. The router 1160 is also coupled to a source of categorization data 1112 and a source of data content 1117. The source of categorization data 1112 may be the trusted third-party selected by the user or may be, for example, an intermediary that organizes the categorization data provided by the trusted third-party.

The router 1160 may include a server 1100 that may include a controller 1105, a discrimination processor 1107 and a memory 1110 coupled together by a data/control bus 1170. The memory 1110 may include a database 1125 that includes service profile information for at least one, and potentially a plurality of, user service profile(s). The database 1125 may also contain the categorization data provided by the source 1112. Alternatively, the categorization data may be stored in a separate database (not shown) or in a separate memory (not shown). The data content 1120 provided by the source 1117 may be input to and stored in memory 1125 using data path 1175. Alternatively, the data content 1120 may be stored in a separate memory (not shown). The data content may be a list of web-links identified by a conventional search engine, a list of web-links identified by the trusted third-party or any other list of information that indicates and corresponds to data content.

The controller 1105 controls the discrimination processor to determine what data content 1120 should be presented to an audience on the presentation apparatus 1155 based on the discrimination criteria in the service profile stored in the database 1125 and the categorization data 1115 provided by the trusted third-party. Based on this determination, the discrimination processor formulates index data which, is transmitted to the CPE 1135 along with the data content 1120. The transmission may be performed over either data/control path 1130 or over path 1185 that may or may not include a public network such as the Internet 1180.

Within the CPE 1135, the controller 1150 controls the memory 1140, the transceiver 1145 and the processor 1190 using the control/data bus 1165, which couples the memory 1140, transceiver 1145, the processor 1190 and the controller 1150. The CPE 1135 receives the index data and the data content 1120 via the transceiver 1145 and both the index data and the data content 1120 are stored in memory 1140 under direction by the controller 1150. Alternatively, the index data may be stored in a memory that is separate (not shown) from a memory that stores the data content 1120. Under the direction of the controller 1150, the processor 1190 formulates a presentation index based on comparison between the received data content 1120 and the index data.

The processor 1190 then selectively enables presentation of the data content 1120 on the presentation apparatus 1155 based on the index data. Additionally, the controller 1150 controls the processor 1190 to output the formulated presentation index to the presentation apparatus so that an audience can determine what data content is available for presentation.

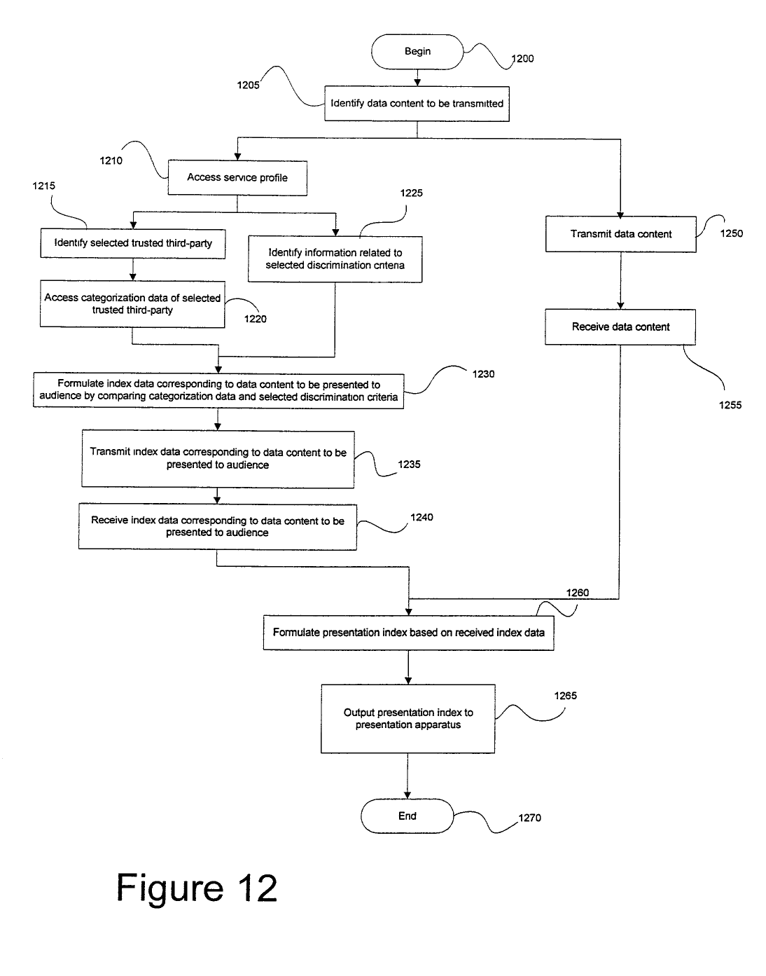

FIG. 12 is a flowchart illustrating one exemplary method for implementing the fifth exemplary embodiment of the invention. As illustrated in FIG. 12, the method begins at 1200, at which control proceeds to 1205. At 1205, the data content to be transmitted is identified. Control then proceeds to 1210, at which a user's service profile is accessed. Control then proceeds to 1215, at which the trusted third-party selected by the user is identified. Control then proceeds to 1220, at which the categorization data provided by the selected, trusted third-party is accessed. The actions performed at 1225 may be performed simultaneously with the actions performed at 1215-1220, or may be performed subsequently or prior to them.

At 1225, information related to and including selected discrimination criteria is identified and control proceeds to 1230. At 1230, index data corresponding to data content to be presented to an audience is formulated by comparing categorization data provided by the selected, trusted-third-party and the selected discrimination criteria in the service profile. Control then proceeds to 1235, at which the formulated index data is transmitted to CPE. Control then proceeds to 1240, at which the index data is received at the CPE. The actions performed at 1250 and 1255 may be performed simultaneously with the actions performed at 1210-1240. Alternatively, the actions performed at 1250 and 1255 may be performed either prior or subsequent to performance of the actions performed at 1210-1240.

At 1250, data content, for example, a list of web-links is transmitted from, for example, a search engine. Control then proceeds to 1265, at which the data content transmitted in 1250 is received, for example, by CPE. Control then proceeds to 1260, at which presentation of all or part of that data content is enabled based on the index data. Control then proceeds to 1265, at which a presentation index is formulated based on the received index data. Control then proceeds to 1270, at which the presentation index is output, for example, to a presentation apparatus, e.g., a monitor or television. Control then proceeds to 1275, at which the method ends.

It is foreseeable that aspects of the fourth and fifth exemplary embodiments to provide lists of labels of textual data content, e.g., lists of book titles, but not provide the textual data content itself, e.g., the text of the books. In such an embodiment, the lists of labels could be selectively presented as in the fifth exemplary embodiment or sorted in an order of significance as determined based on categorization data provided by a trusted third-party and discrimination criteria selected by user.

In accordance with the sixth exemplary embodiment of the invention, data content is sorted based on categorization data provided by a trusted third-party and based on discrimination criteria provided by a user. However, in the sixth exemplary embodiment, the data content is not necessarily schedule-based. Rather, data content may be, for example, text, graphics or multi-media data downloaded from the Internet. The sixth exemplary embodiment of the invention allows a user to select a trusted third-party to supply categorization data corresponding to such downloadable data content.

As in the fifth exemplary embodiment, a significant benefit of the sixth exemplary embodiment over conventional search engine technology is that a user is unaware of how a search engine provides results for a data content information search. Additionally, nothing is known about the party providing the results to a conventional data content query. Moreover, there is no conventional way to sort data content based on a perceived quality of that data content determined by a trusted third-party.

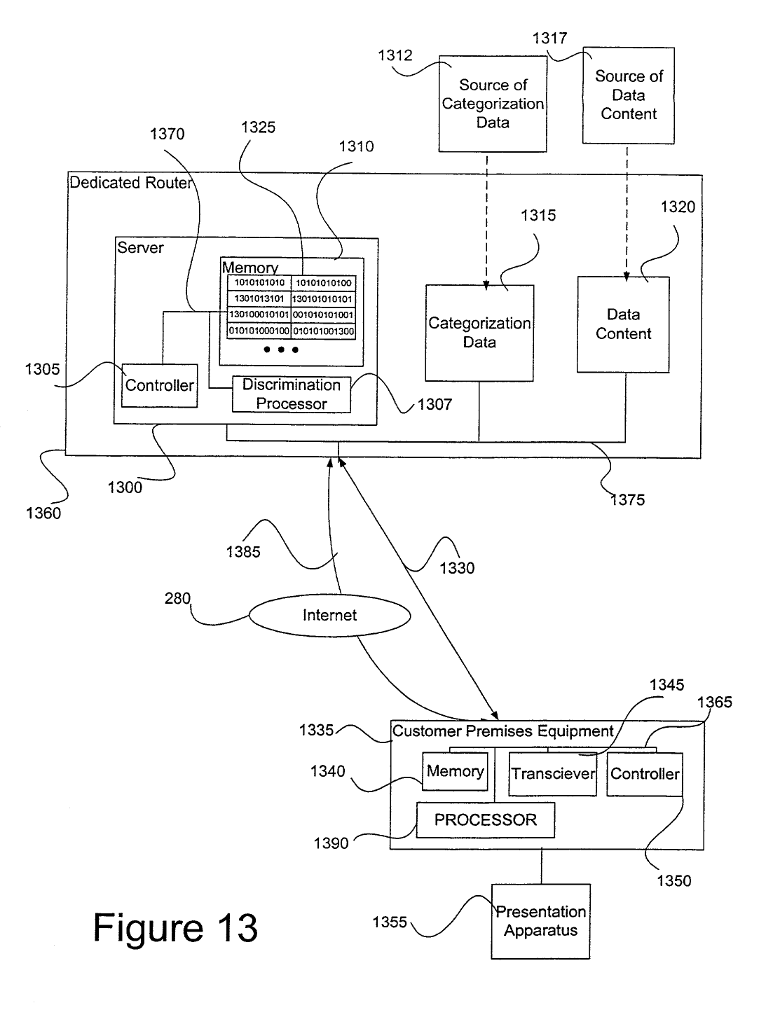

FIG. 13 is a block diagram illustrating one exemplary system architecture that may implement such an exemplary embodiment (the sixth exemplary embodiment) of the invention.

As illustrated in FIG. 13, a system for sorting data content includes a dedicated router 1360 coupled to CPE 1335, which is coupled to a presentation apparatus 1355. The router 1360 is also coupled to a source of categorization data 1312 and a source of data content 1317. The source of categorization data 1312 may be the trusted third-party selected by the user or may be, for example, an intermediary that organizes the categorization data provided by the trusted third-party.

The router 1360 may include a server 1300 that may include a controller 1305, a discrimination processor 1307 and a memory 1310 coupled together by a data/control bus 1370. The memory 1310 may include a database 1325 that includes service profile information for at least one, and potentially a plurality of, user service profile(s). The database 1325 may also contain the categorization data provided by the source 1312. Alternatively, the categorization data may be stored in a separate database (not shown) or in a separate memory (not shown). The data content 1320 provided by the source 1317 may be input to and stored in memory 1325 using data path 1375. Alternatively, the data content 1320 may be stored in a separate memory (not shown). The data content may be a list of web-links identified by a conventional search engine, a list of web-links identified by the trusted third-party or any other list of information that indicates and corresponds to data content.

The controller 1305 controls the discrimination processor to determine how labels corresponding to data content 1320 should be presented to an audience on the presentation apparatus 1355 based on the discrimination criteria in the service profile stored in the database 1325 and the categorization data 1315 provided by the trusted third-party. Based on this determination, the discrimination processor formulates specially formatted index data, which is transmitted to the CPE 1335. The transmission may be performed over either data/control path 1330 or over path 1385 that may or may not include a public network such as the Internet 1380.

Within the CPE 1335, the controller 1350 controls the memory 1340, the transceiver 1345 and the processor 1390 using the control/data bus 1365, which couples the memory 1340, transceiver 1345, the processor 1390 and the controller 1350. The CPE 1335 receives the specially formatted index data via the transceiver 1345 and the index data is stored in memory 1340 under direction by the controller 1350. Alternatively, the index data may be stored in a memory that is separate (not shown) from a memory that stores the data content 1320. Under the direction of the controller 1350, the processor 1390 formulates a specially formulated presentation index based on comparison between the received data content 1320 and the index data.

The processor 1390 then selectively enables presentation of the data content 1320 on the presentation apparatus 1355 based on the index data. Additionally, the controller 1350 controls the processor 1390 to output the specially formulated presentation index to the presentation apparatus 1355 so that an audience can determine what data content is most appropriate for presentation.

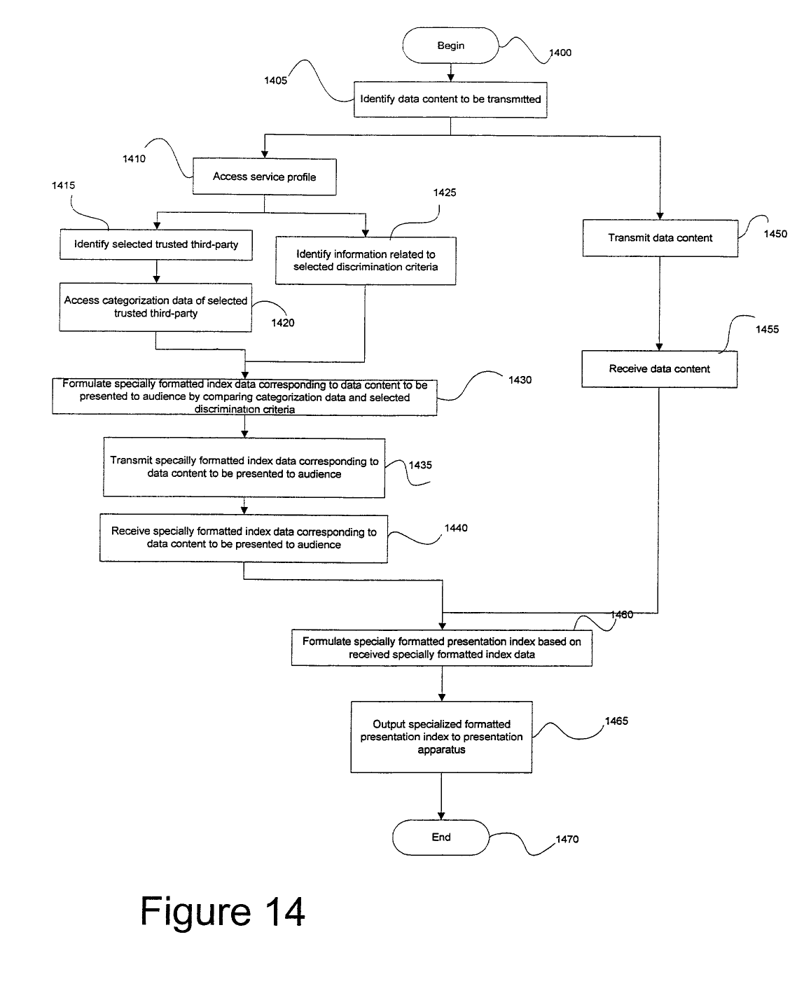

FIG. 14 is a flowchart illustrating one exemplary method for implementing the sixth exemplary embodiment of the invention. As illustrated in FIG. 14, the method begins at 1400, at which control proceeds to 1405. In 1405, the data content to be transmitted is identified. Control then proceeds to 1410, at which a user's service profile is accessed. Control then proceeds to 1415, at which the trusted third-party selected by the user is identified. Control then proceeds to 1420, at which the categorization data provided by the selected, trusted third-party is accessed. The actions performed at 1425 may be performed simultaneously with the actions performed at 1415-1420, or may be performed subsequently or prior to them.

At 1425, information related to and including selected discrimination criteria is identified and control proceeds to 1430. At 1430, specially formatted index data corresponding to data content to be presented to an audience is formulated by comparing categorization data provided by the selected, trusted-third-party and the selected discrimination criteria in the service profile. This specially formatted index data indicates which data content incorporated in data content 1420 is most appropriate for presentation to at least one audience based on the categorization data and the discrimination criteria. Control then proceeds to 1435, at which the specially formulated index data is transmitted to, for example, the user's CPE. Control then proceeds to 1440, at which the specially formatted index data is received at the user's CPE and control proceeds to 1450.

The actions performed at 1450 and 1455 may be performed simultaneously with the actions performed at 1410-1440. Alternatively, the actions performed at 1450 and 1455 may be performed either prior or subsequent to performance of the actions performed at 1410-1440.

At 1450, data content, for example, data content available at various web-pages on the Internet. Control then proceeds to 1455, at which the data content transmitted at 1450 is received, for example, by CPE. Control then proceeds to 1460, at which a specially formatted presentation index is formulated based on the index data. Control then proceeds to 1465, at which the specially formatted presentation index is output, for example, to a presentation apparatus. Control then proceeds to 1470, at which the method ends.

In accordance with the sixth exemplary embodiment, it is foreseeable that the method and architecture used to provide the specially formatted presentation index of data content labels may show data sorted by appropriateness but, also, only data content that has been determined to be of a minimum-level of appropriateness. Thus, it should be appreciated that aspects of the sixth exemplary embodiment of the invention may be combined with the aspects of the fifth exemplary embodiment of the invention.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of the invention.

For example, it is foreseeable that it may be preferable that the selective presentation or sorting of data content according to any of the exemplary embodiments may be overridden so that all data content is presentable regardless of discrimination criteria. Such may be the case when a service profile is used to selectively present only age-appropriate television programming to children in a household during weekdays, but, a parent is at home due to illness or vacation. By allowing entry of an override code, e.g., that is known by a parent but not be the children, for example, a password described above, the parent is able to view television programs that he would not normally allow his children to view. Such an override code may be personal to an individual in a household, for example, an older child, a parent, etc., or may be known by all members of the household except for those children for whom certain data content is inappropriate. Additionally, it is also foreseeable that the exemplary embodiments of the invention may prompt an audience for an enablement code. This password might identify the identity of the audience, e.g., Jane Doe, or a characteristic of that audience, e.g. between age thirteen and age 15, and enable the audience to be exposed to certain data.

Also, it is foreseeable that in accordance with the first through fourth exemplary embodiments of the invention, a presentation index may be output only after an audience enters a password. For example, entry of the password may initiate display of a television schedule that includes programs selected specifically for that audience.

Additionally, it is foreseeable that the systems and equipment designed in accordance with the exemplary embodiments of the invention may receive information relating to discrimination criteria that will limit not only the type of data content presented but also an amount of data content presented over a period of time. Such a capability may be beneficial in such a situation when a user, e.g., a parent, wants to control the quality of data content presented to an audience, e.g., a child or children, and also the quantity of data content presented to an audience, e.g., three hours of television programming per week between the hours of 2:00 pm and 6:00 pm on weekdays.

Furthermore, it should be appreciated that the server illustrated in FIGS. 2, 4, and 6, may or may not be located in whole or in part at a head-end, for example, as used in a cable television service operation.

Also, as explained above, in accordance with at least one exemplary embodiment of the invention, a data content presentation apparatus is selectively enabled to present data content, which is determined to be appropriate, based on an analysis of categorization data by a trusted third-party and discrimination criteria. Appropriate data content is that which satisfies discrimination criteria to a specified degree. It should be appreciated that the degree of satisfaction may be any of a number of different levels, e.g., strict, moderate or lax adherence. For example, it is foreseeable that a user may want strict adherence to the discrimination criteria that he/she selected. In such a situation, it should be appreciated that, when selective presentation is performed, only data content fulfilling the user's discrimination criteria is presented. Additionally, it should be appreciated that, when sorting of data content is performed, data content is sorted such that only the data content most closely meeting the user's discrimination criteria being identified as most appropriate for presentation to the audience.

Also, the index data, whether it be included in schedule-based EPG data or not, need not be transmitted over a separate, distinct channel but, rather, may be multiplexed onto one or more, or all of the channels that are receivable by a presentation apparatus.

It is foreseeable that the schedule-based data content 220 and, optionally, the schedule-based categorization data 215, may be compiled by a schedule-data provider, which may be a suitable program schedule service. This schedule-based data content 220 may be transmitted to the systems illustrated in FIGS. 2, 4, 6 and 8 in, for example, a cable distribution system. This schedule-based data content 220 may comprise broadcast data content corresponding to an hour, day, week, or month. Similarly, the schedule based categorization data 215 may comprise categorization data corresponding to broadcast data content corresponding to an hour, day, week, or month. Accordingly, the categorization data 215 and data content 220 may be transmitted hourly, daily, weekly or monthly from sources 212 and 217, respectively. Similarly, index data and data content may be transmitted to users' CPE in a cable distribution system periodically and, potentially, over a channel distinct from those channels over which schedule-based data content are transmitted.

It will be appreciated that the transmission of schedule-based categorization data from a schedule data provider or a trusted third-party to the system may be performed by way of conventional communication channels, such as telephone lines, optical channels, predetermined radio channels, or the like. Thus, index data, for all data content being broadcast over a certain period, e.g., a week, may be transmitted from the system to a user's CPE. However, the index data may identify data content that is broadcast for a greater period of time than simply one week, and it is contemplated that the index data formulated at the system controller may represent those television programs that are to be transmitted over a period of many weeks. Therefore, it should be appreciated that transmission of index data need not be performed in tandem with the data content associated with that index data.

It is foreseeable that each individual at a customer premises may have his/her own set of discrimination criteria as well as a personal identification code associated with their set of discrimination criteria, which is also a password. Accordingly, the personal code may be used to select which discrimination criteria set is enabled from among a plurality of discrimination criteria sets. It should be appreciated that the exemplary embodiments of the invention may be used in combination or in conjunction with existing technology, e.g., v-chip technology. It should also be appreciated that each of the exemplary embodiments of the invention may be used in combination in whole or in part with other of the exemplary embodiments of the invention. Each of the exemplary embodiments of the invention may be implemented in hardware, software or in some combination thereof.

Finally, although it is preferable that a user be given the opportunity to select a trusted third-party during initialization of a service profile, it is foreseeable that a default trusted third-party may be set upon initialization. A user would then have the opportunity to select an alternative trusted third-party.

We claim:

1. A method for setting data for discriminating whether to present at least one piece of data content to an audience, the method comprising:
presenting a plurality of potential discrimination criteria to a user for review by the user;
receiving input selection data that indicates selection of at least one of the plurality of potential discrimination criteria as a selected discrimination criterion; and
storing data identifying the selected discrimination criterion;
presenting a plurality of potential trusted third parties to a user for review by the user;
receiving input selection data that indicates selection of at least one of the plurality of potential trusted third-parties as a selected trusted third-party; and
storing data identifying the selected trusted third party, wherein each of the plurality of potential discrimination criteria indicate at least one characteristic potentially associated with the at least one piece of data content.

2. The method of claim 1, wherein presenting is performed by displaying the plurality of potential discrimination criteria using a graphical user interface.

3. The method of claim 1, wherein the at least one characteristic indicates subject matter of the at least one piece of data content.

4. The method of claim 3, wherein the at least one characteristic includes a level of activity contained in the subject matter of the at least one piece of data content.

5. The method of claim 1, wherein receiving input selection data includes receiving a time range during which the selected discrimination criterion should be used to discriminate whether to present the at least one piece of delivered data content to the audience.

6. A method for selectively presenting at least one piece of data content to an audience based on at least one selected discrimination criterion selected by a user and categorization data provided by at least one selected, trusted third-party selected by the user, the method comprising:
setting the at least one selected discrimination criterion;
setting the at least one selected, trusted third-party;
reviewing categorization data indicative of the at least one piece of data content provided by the selected, trusted third-party;
discriminating whether the at least one piece of data content meets the at least one selected discrimination criterion selected by the user based on a comparison between the categorization data and the at least one discrimination criterion; and
formulating index data that indicates whether the at least one piece of data content meets the at least one selected discrimination criterion selected by the user.

7. The method of claim 6, further comprising selectively outputting to a presentation apparatus only data content indicated by the index data as meeting the at least one discrimination criteria selected by the user.

8. The method of claim 6, further comprising selectively receiving at customer premises equipment only data content indicated by the index data as meeting the at least one discrimination criteria selected by the user.

9. The method of claim 6, further comprising selectively transmitting only data content indicated by the index data as meeting the at least one discrimination criteria selected by the user.

10. The method of claim 6, wherein setting the at least one selected discrimination criterion includes:
presenting a plurality of potential discrimination criteria to a user for review by the user;
receiving input selection data that selects at least one of the plurality of potential discrimination criteria as a selected discrimination criterion; and
storing the selected discrimination criterion.

11. The method of claim 10, wherein each of the plurality of potential discrimination criteria indicate at least one characteristic potentially associated with the at least one piece of data content.

12. The method of claim 11, wherein the at least one characteristic indicates subject matter of the at least one piece of data content.

13. The method of claim 12, wherein the at least one characteristic includes a level of an activity potentially associated with the at least one piece of delivered data content.

14. The method of claim 12, wherein receiving input selection data includes receiving a time range during which the selected discrimination criterion should be used to discriminate whether to present the at least one piece of data content to the audience.

15. The method of claim 6, wherein setting the at least one selected, trusted third-party comprises:
presenting a plurality of potential trusted third parties to a user for review by the user;
receiving input selection data that indicates selection of at least one of the plurality of potential trusted third-parties as a selected trusted third-party; and
storing data identifying the selected trusted third party.

16. The method of claim 15, wherein each of the plurality of potential trusted third-parties provides categorization data about the at least one piece of data content.

17. The method of claim 6, wherein the at least one selected discrimination criterion is schedule-based in that the at least one selected discrimination criterion includes an indication of a time range during which the at least one selected discrimination criterion should be used discriminate whether the at least one piece of data content should be presented to the audience.

18. The method of claim 6, wherein the categorization data is schedule-based in that the categorization data corresponds to data content, including the at least one piece of data content, that is broadcast based on a schedule.

19. The method of claim 6, wherein the at least one piece of data content is audio-visual data.

20. The method of claim 6, wherein the at least one piece of data content is audio data.

21. The method of claim 6, wherein the at least one piece of data content is multimedia data.

22. The method of claim 6, wherein the at least one piece of data content is text data.

23. A method for optimizing presentation of at least one piece of data content based on at least one selected discrimination criterion and categorization data provided by a trusted third-party, the method comprising:
setting the at lest one selected discrimination criterion;
setting the at least one selected, trusted third-party;
reviewing categorization data indicative of the at least one piece of data content; and
performing a comparison between the categorization data and the at lest one discrimination criterion;
discriminating whether a label associated with the at least one piece of data content should be included in a data content index based on the comparison between the schedule-based categorization data and the at least one discrimination criterion;
presenting the data content index to an audience.

24. The method of claim 23, wherein setting the at least one selected discrimination criterion includes:
presenting a plurality of potential discrimination criteria to a user for review by the user;
receiving input selection data that selects at least one of the plurality of potential discrimination criteria as a selected discrimination criterion; and
storing the selected discrimination criterion.

25. The method of claim 24, wherein each of the plurality of potential discrimination criteria indicate at least one characteristic potentially associated with the at least one piece of data content.

26. The method of claim 25, wherein the at least one characteristic indicates subject matter of the at least one piece of data content.

27. The method of claim 25, wherein the at least one characteristic includes a level of the activity potentially associated with the at least one piece of data content.

28. The method of claim 24, wherein the at least one piece of data content is text data.

29. The method of claim 24, wherein the at least one piece of data content is audio-visual data.

30. The method of claim 24, wherein the at least one piece of data content is audio data.

31. The method of claim 24, wherein the at least one piece of delivered data content is multimedia data.

32. Customer premises equipment that selectively presents at least one piece of data content to an audience based on at least one selected discrimination criterion, the customer premises equipment comprising:
a transceiver that receives categorization data, a portion of which is formulated by a trusted third-party selected by a user, associated with the at least one piece of data content;
an interface that receives at least one selected discrimination criterion from a user;
a memory that is coupled to both the transceiver and the interface and that stores index data indicating data content meeting the at least one selected discrimination criterion;
a processor that is coupled to the memory and formulates a presentation index listing data content that meets the at least one selected discrimination criterion based on the index data stored in the memory; and
a controller that is coupled to and controls operation of the transceiver, interface, memory and processor.

33. The customer premises equipment of claim 32, wherein the interface includes a display that presents a plurality of potential discrimination criteria to a user.

34. The customer premises equipment of claim 33, wherein the display presents the plurality of potential discrimination criteria using a graphical user interface.

35. The customer premises equipment of claim 32, wherein each of the plurality of potential discrimination criteria indicate at least one characteristic potentially associated with the at least one piece of data content.

36. The customer premises equipment of claim 35, wherein the at least one characteristic indicates subject matter of the at least one piece of delivered data content.

37. The customer premises equipment of claim 35, wherein the at least one characteristic includes a level of an activity potentially associated with the at least one piece of data content.

38. The customer premises equipment of claim 32, wherein the at least one selected discrimination criterion includes indication of a time range during which the selected discrimination criterion should be used to discriminate whether to present the at least one piece of data content to the audience.

39. The customer premises equipment of claim 32, wherein the at least one piece of data content is text data.

40. The customer premises equipment of claim 32, wherein the at least one piece of data content is audio-visual data.

41. The customer premises equipment of claim 32, wherein the at least one piece of delivered data content is audio data.

42. The customer premises equipment of claim 32, wherein the at least one piece of delivered data content is multimedia data.

43. The customer premises equipment of claim 32, wherein the controller controls the processor to output only data content indicated by the index data as meeting the at least one discrimination criteria selected by the user.

44. The customer premises equipment of claim 32, wherein the controller controls the transceiver to receive only data content indicated by the index data as meeting the at least one discrimination criteria selected by the user.

45. The customer premises equipment of claim 32, wherein the transceiver receives only data content indicated by the index data as meeting the at least one discrimination criteria selected by the user.

46. The customer premises equipment of claim 32, wherein the at least one selected discrimination criterion is schedule-based in that the at least one selected discrimination criterion includes an indication of a time range during which the at least one selected discrimination criterion should be used discriminate whether the at least one piece of data content should be presented to the audience.

47. The customer premises equipment of claim 32, wherein the categorization data is schedule-based in that the categorization data corresponds to data content, including the at least one piece of data content, that is broadcast based on a schedule.

48. A system that selectively presents at least one piece of data content to an audience based on at least one selected discrimination criterion selected by a user and categorization data provided by at least one selected, trusted third-party selected by the user, the system comprising:
a memory that stores information related to the at least one selected discrimination criterion and the trusted third-party;
a processor that is coupled to the server and generates index data by analyzing data content should be presented based on the selected discrimination criterion and the trusted third-party; and
customer premises equipment that selectively presents at least one piece of data content to an audience based on the index data.
